(19) United States
(12) Patent Application Publication
(10) Pub. No.: US 2017/0019306 A1
(43) Pub. Date: Jan. 19, 2017

(54) TECHNIQUES FOR SUPPORTING DEFINITIONS FOR REDUCED NUMBERS OF SPATIAL STREAMS

(71) Applicant: QUALCOMM Incorporated, San Diego, CA (US)

(72) Inventors: Albert VAN ZELST, Woerden (NL); Maarten Menzo WENTINK, Naarden (NL)

(21) Appl. No.: 15/207,736

(22) Filed: Jul. 12, 2016

Related U.S. Application Data
(60) Provisional application No. 62/193,067, filed on Jul. 15, 2015.

(51) Int. Cl. H04L 12/24; H04W 28/20

(52) U.S. Cl. CPC H04L 41/0896; H04W 28/20

(57) ABSTRACT

A method and apparatuses for wireless communication are described herein. An exemplary method may include generating a frame comprising: at least one bit indicating an operating bandwidth mode associated with a set of bandwidths, a first field having a value indicating a first number of spatial streams supported by the apparatus associated with a first subset of the set of bandwidths, and one or more bits indicating how the value of the first field is to be processed for determining a second number of spatial streams supported by the apparatus on a given bandwidth in the set of bandwidths for transmission of one or more packets to the apparatus; and outputting the frame for transmission. Complementary operations may be performed by a device receiving the frame.

### CROSS-REFERENCE TO RELATED APPLICATIONS

The present application for patent claims priority to U.S. Provisional Application No. 62/193,067, filed Jul. 15, 2015, which is assigned to the assignee of the present application and hereby expressly incorporated by reference herein in its entirety.

### BACKGROUND

Field of the Disclosure

The present disclosure relates to wireless communication systems, and more particularly to wireless devices capable of supporting multiple bandwidth modes.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) that may communicate with one or more stations (STAs) or mobile devices. The AP may be coupled to a network, such as the Internet, and enable a mobile device to communicate via the network (and/or communicate with other devices coupled to the access point).

A wireless network may define multiple bandwidth modes specifying the bandwidth of channels used by wireless devices (e.g., 20 MHz, 40 MHz, 80 MHz, etc.) to communicate over the network. Some networks may permit the combination of multiple channels using channel bonding to allow for operation over a bandwidth that is larger than that of a single channel. Because some wireless devices may switch between these bandwidth modes, there is a need to efficiently leverage hardware in a wireless device to provide support for multiple bandwidth modes. Additionally, as the number and type of bandwidth modes supported by wireless devices increases, there is a need to provide support for new bandwidth modes while maintaining backwards compatibility with legacy bandwidth modes.

### SUMMARY

In an aspect of the present disclosure, an apparatus for wireless communications is provided. The apparatus generally includes a processing system configured to generate a frame comprising: at least one bit indicating an operating bandwidth mode associated with a set of bandwidths, a first field having a value indicating a first number of spatial streams supported by the apparatus associated with a first subset of the set of bandwidths, and one or more bits indicating how the value of the first field is to be processed for determining a second number of spatial streams supported by the apparatus on a given bandwidth in the set of bandwidths; and an interface configured to output the frame for transmission.

In an aspect of the present disclosure, a method for wireless communications by an apparatus is provided. The method generally includes generating a frame comprising: at least one bit indicating an operating bandwidth mode associated with a set of bandwidths, a first field having a value indicating a first number of spatial streams supported by the apparatus associated with a first subset of the set of bandwidths, and one or more bits indicating how the value of the first field is to be processed for determining a second number of spatial streams supported by the apparatus on a given bandwidth in the set of bandwidths for transmission of one or more packets to the apparatus; and outputting the frame for transmission.

In an aspect of the present disclosure, an apparatus for wireless communications is provided. The apparatus generally includes a first interface configured to obtain a first frame; a processing system configured to determine, based on at least one bit in the first frame, an operating bandwidth associated with a set of bandwidths, to determine, based on a value of a first field in the first frame, a first number of spatial streams supported by a wireless device associated with a first subset of the set of bandwidths, to determine, based on one or more bits in the first frame, how to process the value of the first field, to determine a second number of spatial streams supported by the wireless device on a given bandwidth in the set of bandwidths for reception of a packet, based on the determined processing of the value of the first field, and to generate a second frame for transmission to the wireless device on the given bandwidth using the second number of spatial streams; and a second interface configured to output the second frame for transmission.

In an aspect of the present disclosure, a method for wireless communications by an apparatus is provided. The method generally includes obtaining a first frame, determining, based on at least one bit in the first frame, an operating bandwidth mode associated with a set of bandwidths, determining, based on a value of a first field in the first frame, a number of spatial streams supported by a wireless device associated with a first subset of the set of bandwidths, determining, based on one or more bits in the first frame, how to process the value of the first field, determining a second number of spatial streams supported by the wireless device on a given bandwidth in the set of bandwidths for reception of a packet, based on the determined processing of the value of the first field, generating a second frame for transmission to the wireless device on the given bandwidth using the second number of spatial streams, and outputting the second frame for transmission.

In an aspect of the present disclosure, an apparatus for wireless communications is provided. The apparatus generally includes means for generating a frame comprising: at least one bit indicating an operating bandwidth mode associated with a set of bandwidths, a first field having a value indicating a first number of spatial streams supported by the apparatus associated with a first subset of the set of bandwidths, and one or more bits indicating how the value of the first field is to be processed for determining a second number of spatial streams supported by the apparatus on a given bandwidth in the set of bandwidths for transmission of one or more packets to the apparatus; and means for outputting the frame for transmission.

In an aspect of the present disclosure, an apparatus for wireless communications is provided. The apparatus generally includes means for obtaining a first frame, means for determining, based on at least one bit in the first frame, an operating bandwidth mode associated with a set of bandwidths, means for determining, based on a value of a first field in the first frame, a number of spatial streams supported by a wireless device associated with a first subset of the set of bandwidths, means for determining, based on one or more bits in the first frame, how to process the value of the first field, means for determining a second number of spatial streams supported by the wireless device on a given bandwidth in the set of bandwidths for reception of a packet, based on the determined processing of the value of the first field, means for generating a second frame for transmission to the wireless device on the given bandwidth using the second number of spatial streams, and means for outputting the second frame for transmission.

In an aspect of the present disclosure, a computer readable medium for wireless communications storing computer executable code is provided. The code generally includes instructions for: generating a frame comprising: at least one bit indicating an operating bandwidth mode associated with a set of bandwidths, a first field having a value indicating a first number of spatial streams supported by the apparatus associated with a first subset of the set of bandwidths, and one or more bits indicating how the value of the first field is to be processed for determining a second number of spatial streams supported by the apparatus on a given bandwidth in the set of bandwidths for transmission of one or more packets to the apparatus; and outputting the frame for transmission.

In an aspect of the present disclosure, a computer readable medium for wireless communications storing computer executable code is provided. The code generally includes instructions for: obtaining a first frame, determining, based on at least one bit in the first frame, an operating bandwidth mode associated with a set of bandwidths, determining, based on a value of a first field in the first frame, a number of spatial streams supported by a wireless device associated with a first subset of the set of bandwidths, determining, based on one or more bits in the first frame, how to process the value of the first field, determining a second number of spatial streams supported by the wireless device on a given bandwidth in the set of bandwidths for reception of a packet, based on the determined processing of the value of the first field, generating a second frame for transmission to the wireless device on the given bandwidth using the second number of spatial streams, and outputting the second frame for transmission.

In an aspect of the present disclosure, an access point (AP) is provided. The AP generally includes at least one antenna, a processing system configured to generate a frame comprising: at least one bit indicating an operating bandwidth mode associated with a set of bandwidths, a first field having a value indicating a first number of spatial streams supported by the AP associated with a first subset of the set of bandwidths, and one or more bits indicating how the value of the first field is to be processed for determining a second number of spatial streams supported by the AP on a given bandwidth in the set of bandwidths for transmission of one or more packets to the AP; and at least one transmitter configured to transmit the frame via the at least one antenna.

In an aspect of the present disclosure, a station (STA) is provided. The STA generally includes at least one antenna; at least one receiver configured to receive, via the at least one antenna, a first frame having at least one bit indicating an operating bandwidth mode associated with a set of bandwidths, a first field indicating a first number of spatial streams supported by a wireless device associated with a first subset of the set of bandwidths, and one or more bits in the frame indicating how to process the value of the first field; a processing system configured to: determine, based on the at least one bit, the operating bandwidth mode associated with the set of bandwidths, determine, based on a value of the first field, the first number of spatial streams supported by the wireless device associated with the first subset of the set of bandwidths, determine, based on the one or more bits in the frame, how to process the value of the first field, determine a second number of spatial streams supported by the wireless device on a given bandwidth in the set of bandwidths for reception of a packet, based on the determined processing of the value of the first field, and generate a second frame for transmission to the wireless device on the given bandwidth using the second number of spatial streams; and at least one transmitter configured to transmit, via the at least one antenna, the second frame to the wireless device on the given bandwidth using the second number of spatial streams.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communication system, in accordance with various aspects of the present disclosure.

FIG. 2 shows a conceptual diagram of an example channelization for a wireless communication system, in accordance with various aspects of the present disclosure.

FIG. 3 shows a flow diagram illustrating an example bandwidth mode selection in a wireless communication system, in accordance with various aspects of the present disclosure.

FIG. 4 shows a conceptual diagram of an example wireless communication system operating with four spatial streams, in accordance with various aspects of the present disclosure.

FIG. 5 shows a conceptual diagram of an example wireless communication system operating with two spatial streams, in accordance with various aspects of the present disclosure.

FIG. 6 shows a block diagram of an example digital portion of a physical layer of a transmitter, in accordance with various aspects of the present disclosure.

FIG. 7 shows a block diagram of a device configured for use in wireless communication, in accordance with various aspects of the present disclosure.

FIG. 8 shows a block diagram of a device configured for use in wireless communication, in accordance with various aspects of the present disclosure.

FIGS. 9A and 9B show block diagrams of a wireless communication system, in accordance with various aspects of the present disclosure.

FIG. 10 shows a block diagram of an apparatus for use in wireless communication, in accordance with various aspects of the present disclosure.

FIG. 11 shows a block diagram of an apparatus for use in wireless communication, in accordance with various aspects of the present disclosure.

FIGS. 12A and 12B show block diagrams of a wireless device for use in wireless communication, in accordance with various aspects of the present disclosure.

FIG. 13 illustrates example operations for wireless communication, in accordance with various aspects of the present disclosure.

FIG. 13A illustrates example means capable of performing the operations set forth in FIG. 13.

FIG. 14 illustrates example operations for wireless communication, in accordance with various aspects of the present disclosure.

FIG. 14A illustrates example means capable of performing the operations set forth in FIG. 14.

FIG. 15 illustrates an example operating mode field, in accordance with various aspects of the present disclosure.

FIG. 16 illustrates an example mapping of bits of the operating mode field of FIG. 15, in accordance with various aspects of the present disclosure.

### DETAILED DESCRIPTION

A wireless device may communicate using multiple bandwidth (BW) modes. New wireless devices and wireless protocols may be capable of using different bandwidths that previously were not used. Techniques, devices, and systems described herein provide support for additional bandwidth modes while also providing backwards compatibility for legacy bandwidth modes.

The present disclosure is directed to techniques, devices, and systems for supporting bandwidth modes utilizing channel bonding while also providing backwards compatibility with legacy bandwidth modes. Specifically, a wireless device may advertise support for a first bandwidth mode that utilizes a single channel and a second bandwidth mode that utilizes channel bonding between multiple channels (e.g., channel bonding of two 80 MHz channels to operate over 160 MHz of total bandwidth). Certain IEEE specifications do not support devices having different maximum numbers of spatial streams (N_{SS}) for different channel bandwidths, for example, a first N_{SS} for a bandwidth of 160 MHz or a bandwidth of two 80 MHz channels that are separated in frequency (80+80 MHz) and a second N_{SS} for 80 MHz or lower. Such support would provide an advantage architecturally, allowing a device to use two 80 MHz chains (e.g., receive chains, transmit chains) to transmit or receive one 160/80+80 MHz stream.

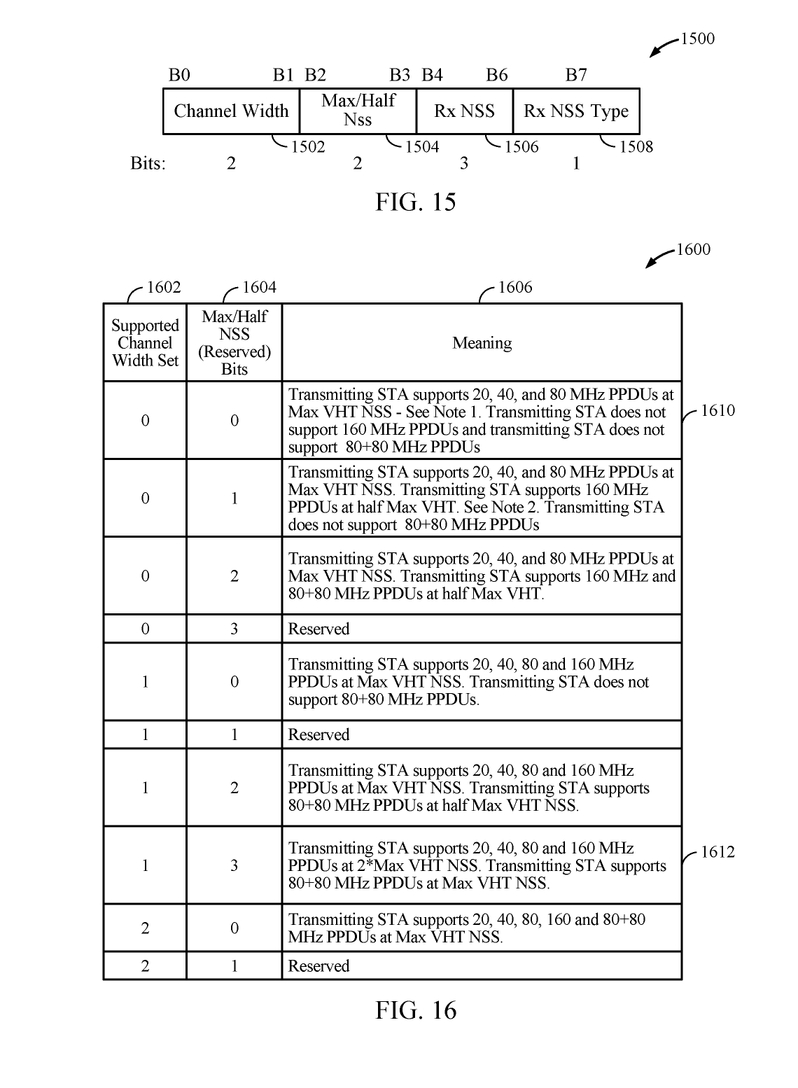

Aspects of the present disclosure provide support for having different N_{SS} for different channel bandwidths, in some cases, through signaling in an Operating Mode field of an Operating Mode Notification. As will be described in greater detail below, various options may be provided to signal such support. For example, in one option, one or more of the (previously) reserved bits in the Operating Mode field may be used to indicate that for 160/80+80 MHz packets, the maximum number of spatial streams (N_{SS}) is reduced from that indicated by the N_{SS} field of the Operating Mode field. According to another option, the one or more (previously) reserved bits of the Operating Mode field may be mapped into a table of possible interpretations of the value of the N_{SS} field (as shown in FIG. 16). Thus, a first wireless device may signal a maximum number of spatial streams for a first bandwidth and a different maximum number of spatial streams for a second bandwidth supported by the first wireless device, and other wireless devices may determine from the signaling the number of spatial streams supported by the first wireless device. The other devices may then transmit signals to or receive signals from the first device on a bandwidth using the supported number of spatial streams for the bandwidth or less than the supported number of spatial streams for the bandwidth.

When a wireless device switches from one of the bandwidth modes to the other of the bandwidth modes, the wireless device may adjust a number of multiple-input, multiple-output (MIMO) spatial streams supported by the wireless device in response to the switching.

For example, if the second bandwidth mode has a total bandwidth that is n times greater than the first bandwidth mode, with n being a positive integer, switching from the first bandwidth mode to the second bandwidth mode may involve reducing the number of MIMO spatial streams supported by the wireless device by

$$\frac{1}{n} .$$

similarly, switching from the second bandwidth mode to the first bandwidth mode may involve increasing the number of MIMO spatial streams supported by the wireless device by a factor of n. Using this technique and others described herein, support for the second bandwidth mode may be provided without increasing the number of hardware components or complexity of the circuits in the wireless device beyond what is used to support the first bandwidth mode. In other examples, support for the second bandwidth mode may be achieved using techniques described herein with minor increases to the number of hardware components or circuit complexity.

Three options are described herein for a wireless device to support an additional 160 MHz bandwidth mode using two spatial streams while supporting 20, 40, and 80 MHz bandwidth modes. The wireless device may also support an 80+80 MHz and a 165 MHz bandwidth mode. The wireless device may utilize channel bonding in order to combine smaller segments (e.g., 80 MHz) into a larger (e.g., 160 MHz) channel. In a first option, a synthesizer for each segment is used in the one or more transceivers to combine two segments into a larger segment. In a second option, two analog-to-digital converters (ADCs) are used in the radio frequency (RF) chains at a different sampling rate in order to create a larger channel. In one example, the sampling rate of the ADCs is doubled (e.g., 160 million samples per second (Msps) is doubled to 320 Msps). In a third option, two synthesizers and increased ADC speeds may be used.

Throughout this description, the bandwidth modes supported by the IEEE 802.11 ac standard are discussed as an example. However, the techniques and devices described herein may extend to other standards and other bandwidths. The IEEE 802.11 ac standard defines a 160 MHz bandwidth mode consisting of two 80 MHz sub-channels (i.e., frequency segments) where each sub-channel has the same number of tones and pilots as a single 80 MHz 11ac channel. Other bandwidth modes supported by the IEEE 802.11 ac standard include a 20 MHz bandwidth mode, a 40 MHz bandwidth mode, and an 80 MHz bandwidth mode. As used throughout the description, a wireless device may refer to either an access point or a wireless device.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

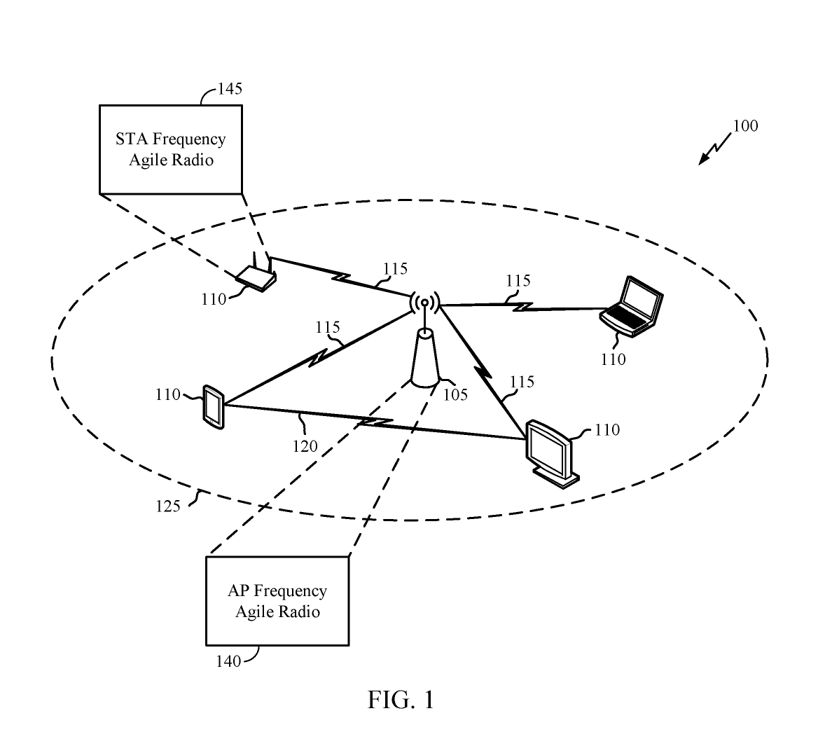

Referring first to FIG. 1, a block diagram illustrates an example of a WLAN network 100 such as, e.g., a network implementing at least one of the IEEE 802.11 family of standards. The WLAN network 100 may include an access point (AP) 105 and one or more wireless devices 110 or stations (STAs), such as mobile stations, personal digital assistants (PDAs), other handheld devices, netbooks, notebook computers, tablet computers, laptops, display devices (e.g., TVs, computer monitors, etc.), printers, and the like. While only one AP 105 is illustrated, the WLAN network 100 may have multiple APs 105. Each of the wireless devices 110, which may also be referred to as mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that wireless devices 110 within that area can typically communicate with the AP 105. The wireless devices 110 may be dispersed throughout the geographic coverage area 125. Each wireless device 110 may be stationary or mobile.

A wireless device 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) is used to connect APs 105 in an extended service set. A geographic coverage area 125 for an access point 105 may be divided into sectors making up only a portion of the coverage area. The WLAN network 100 may include access points 105 of different types (e.g., metropolitan area, home network, etc.), with varying sizes of coverage areas and overlapping coverage areas for different technologies. In other examples, other wireless devices can communicate with the AP 105.

While the wireless devices 110 may communicate with each other through the AP 105 using communication links 115, each wireless device 110 may also communicate directly with one or more other wireless devices 110 via a direct wireless link 120. Two or more wireless devices 110 may communicate via a direct wireless link 120 when both wireless devices 110 are in the AP geographic coverage area 125 or when one or neither wireless device 110 is within the AP geographic coverage area 125. Examples of direct wireless links 120 may include Wi-Fi Direct connections, connections established by using a Wi-Fi Tunneled Direct Link Setup (TDLS) link, and other P2P group connections. The wireless devices 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, and the like. In other implementations, other peer-to-peer connections and/or ad hoc networks may be implemented within WLAN network 100.

The AP 105 may include an AP frequency agile radio 140. A frequency agile radio is a transceiver that can dynamically change bandwidth modes. The bandwidth modes may utilize different frequency channels, and may include an 80 MHz mode, an 80+80 MHz mode, a 160 MHz contiguous mode, and a 165 MHz mode. In other examples, other bandwidth modes may be used. The AP 105 may communicate with the wireless devices 110 or other APs over different bandwidths using the AP frequency agile radio 140.

At least one of the wireless devices 110 may also include a station frequency agile radio 145. The STA frequency agile radio 145 can also dynamically change bandwidth modes to communicate with another wireless device 110 or the AP 105 over a selected bandwidth mode. The selected bandwidth mode may be, for example, the 80 MHz mode, the 80+80 MHz mode, the 160 MHz mode, and the 165 MHz mode. In other examples, the STA frequency agile radio 145 may use other bandwidth modes.

In some examples, the AP frequency agile radio 140 and the STA frequency agile radio 145 may conform to the second release of the 802.11ac standard. The AP frequency agile radio 140 and the STA frequency agile radio 145 may also be backwards compatible with the first release of the 802.11 ac standard.

Several different options are described herein for achieving channel bonding to create a larger segment out of two smaller segments. In one option, the wireless device may use synthesizers (e.g., one synthesizer for each receive chain or a set of receive chains tuned to the same segment) to combine two 80 MHz segments into a two spatial stream 80+80 MHz segment. In another option, the wireless device may use increased sampling rates of one or more ADCs to capture the entire 160 MHz channel. Alternatively, the wireless device may use a combination of synthesizers and increased sampling rates of ADCs in order to have a larger bandwidth, including the 80+80 as well as the 160 MHz segments.

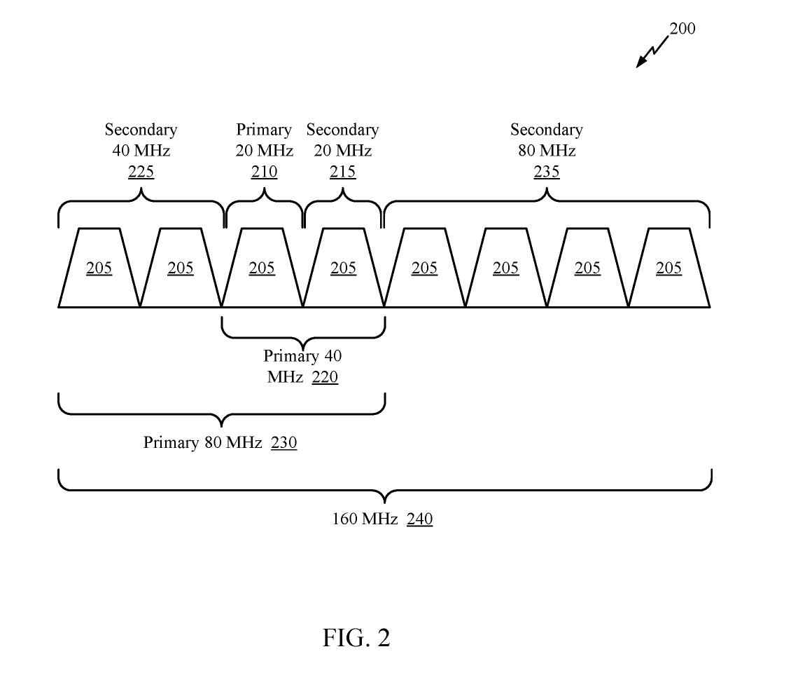

FIG. 2 shows a conceptual diagram of an example channelization 200 for a wireless communication system, in accordance with various aspects of the present disclosure. The channelization 200 may define the available channels for the wireless communication. In this example, the wireless communication system may be between any combination of APs 105 and wireless devices 110 described with reference to FIG. 1. That is, an AP 105 or a wireless device 110 may use the channelization 200 for wireless communications.

In the example of FIG. 2, the channelization 200 includes eight 20 MHz sub-channels 205. The channelization 200 may include a primary 20 MHz channel 210, a secondary 20 MHz channel 215, a primary 40 MHz channel 220, a secondary 40 MHz channel 225, a primary 80 MHz channel 230, and a secondary 80 MHz channel 235. Typically in 802.11ac, an AP 105 selects a channel bandwidth, such as 80 MHz, and when wireless devices 110 connect to the AP 105, the use of sub-channels may be as follows: a 20 MHz wireless device 110 will communicate with the AP 105 over the primary 20 MHz channel 215; a 40 MHz wireless device 110 will communicate with the AP 105 over the primary 20 MHz channel 215 when sending 20 MHz packets and over the primary 40 MHz channel 220 when sending 40 MHz packets; an 80 MHz wireless device 110 will communicate with the AP 105 over the primary 20 MHz channel 215 when sending 20 MHz packets, over the primary 40 MHz channel 220 when sending 40 MHz, and over the primary 80 MHz channel 230 when sending 80 MHz packets.

However, devices and techniques described herein support a channelization 200 also having a 160 MHz channel 240. The 160 MHz channel 240 may include all eight 20 MHz sub-channels 205. The 160 MHz channel 240 may include both of the 80 MHz channels 230, 235. When the 160 MHz channel 240 is selected, the AP 105 or the wireless device 110 may communicate using 160 MHz. The 160 MHz channel 240 may use a simple extension to the channel access rules applicable for 80 MHz channels 230, 235. Channel bonding may be used to combine sub-channels into larger channels, such as the 160 MHz channel 240.

The sub-channels 205 may be contiguous in frequency or may be separated in frequency. In some examples, two or more smaller channels (i.e., frequency segments) that are discontiguous (i.e., separated by a frequency gap) may be combined to create a larger channel, via a frequency synthesizer, for example. An example of this includes a 160 MHz channel made out of two 80 MHz channels, such as the primary 80 MHz channel 230 and the secondary 80 MHz channel 235, where the 80 MHz channels 230, 235 are separated by a frequency gap. Such a 160 MHz channel may be referred to as an 80+80 channel.

The channels 205-240 may be used with different numbers of spatial streams (SS), depending on how many spatial streams the AP 105 or wireless device 110 supports. For example, the primary 80 MHz channel 230 may be used with two or four spatial streams. Likewise, the secondary 80 MHz channel 235 may be used with two or four spatial streams. The 160 MHz channel 240 may use one or two spatial streams. Similarly, the 80+80 MHz channel may use two spatial streams.

The example of FIG. 2 illustrates specific 20 MHz sub-channels 205 being used for each of the bandwidth modes. However, in other examples, sub-channels with bandwidths other than 20 MHz may be used to make up the various bandwidth modes. An AP 105 may select which sub-channels 205 to use as a primary channel. The primary channel may be used as a control channel and for the lowest bandwidth transmissions. In some examples, as long as the primary channel is defined, the other sub-channels will be known by the AP 105 and the wireless devices 110 in communication with the AP 105.

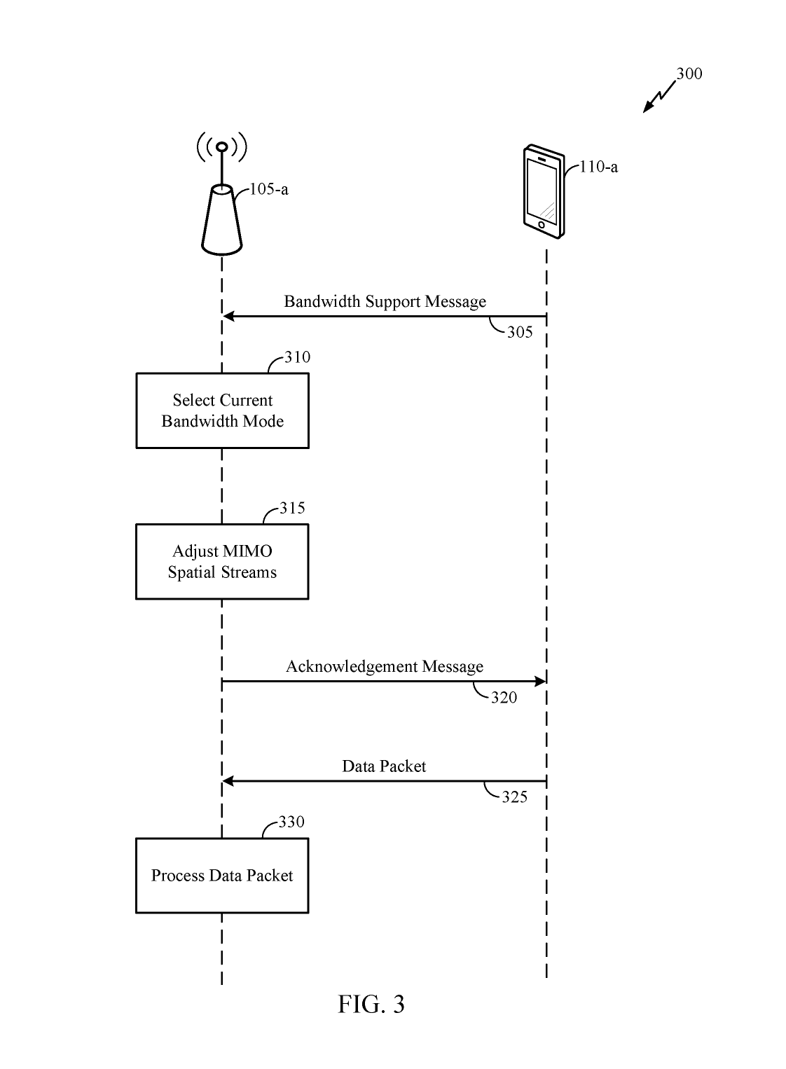

FIG. 3 shows a flow diagram illustrating an example bandwidth mode selection in a wireless communication system 300, in accordance with various aspects of the present disclosure. In this example, an access point 105-a selects a current bandwidth mode based on a bandwidth of a wireless device 110-a. The access point 105-a may be an example of one or more aspects of the AP 105 described with reference to FIG. 1. Similarly, the wireless device 110-a may be an example of one or more aspects of the wireless devices 110 described with reference to FIG. 1.

The wireless device 110-a transmits a bandwidth support message 305 to the AP 105-a when the wireless device 110-a wishes to communicate with the AP 105-a. The bandwidth support message 305 may advertise support by the wireless device 110-a for at least a first bandwidth mode and a second bandwidth mode. For example, the bandwidth support message 305 may advertise that the wireless device 110-a may support an 80 MHz bandwidth mode and a 160 MHz bandwidth mode. In some examples, the bandwidth support message 305 may identify that the wireless device 110-a supports the 160 MHz bandwidth mode, and may be presumed to also support a second bandwidth mode, such as the 80 MHz bandwidth mode. In some examples, the bandwidth support message 305 may identify a selected bandwidth that the wireless device 110-a intends to use. In some examples, the wireless device 110-a may send the bandwidth support message 305 in response to receiving a signal from the AP 105-a.

The AP 105-a may determine a bandwidth mode to use to communicate with the wireless device 110-a based at least in part on a bandwidth mode identified as supported in the received bandwidth support message 305. If the AP 105-a supports the identified bandwidth mode, the AP 105-a selects a current bandwidth mode to be the identified bandwidth mode at block 310. The AP 105-a may restrict communications with the wireless device 110-a to only those modes identified as supported by the wireless device 110-a. The AP 105-a may communicate using other bandwidth modes with other wireless devices 110 associated with the AP 105-a. However, the AP 105-a may not exceed a current channel bandwidth selected for the BSS of which the AP 105-a is a part.

If needed, the AP 105-a may adjust the number of MIMO spatial streams used for the selected current bandwidth mode at block 315. For example, the AP 105-a may adjust the number of MIMO spatial streams used to two or four spatial streams dedicated to the current bandwidth mode.

In some examples, the AP 105-a may send an acknowledgment message 320 to the wireless device 110-a that informs the wireless device 110-a of the bandwidth mode to use to communicate with the AP 105-a. For example, the acknowledgment message 320 may indicate that the wireless device 110-a may operate in the identified bandwidth mode identified in the bandwidth support message 305. In other examples, the AP 105-a does not send the acknowledgment message 320.

The wireless device 110-a may send one or more data packets 325 over the current bandwidth mode to the AP 105-a. For example, the one or more data packets 325 may be sent using a 160 MHz channel if that is the channel that is currently being used. The AP 105-a may process the one or more data packets at block 330. The AP 105-a and the wireless device 110-a may support per-packet switching. That is, depending on medium availability, the AP 105-a may choose a bandwidth mode from packet to packet. For example, the AP 105-a may select to use the 80 MHz channel bandwidth (e.g., with a maximum of up to four spatial streams) for a first packet and then may switch to another bandwidth mode, such as the 80+80 MHz (e.g., with a maximum of up to two spatial streams).

FIG. 3 is illustrated as the AP 105-a announcing the bandwidth capabilities and selecting a current bandwidth mode. However, in other examples, the wireless device 110-a may perform the role attributed to the AP 105-a in FIG. 3. Similarly, the AP 105-a may send a bandwidth support message 305 to the wireless device 110-a or to another AP 105.

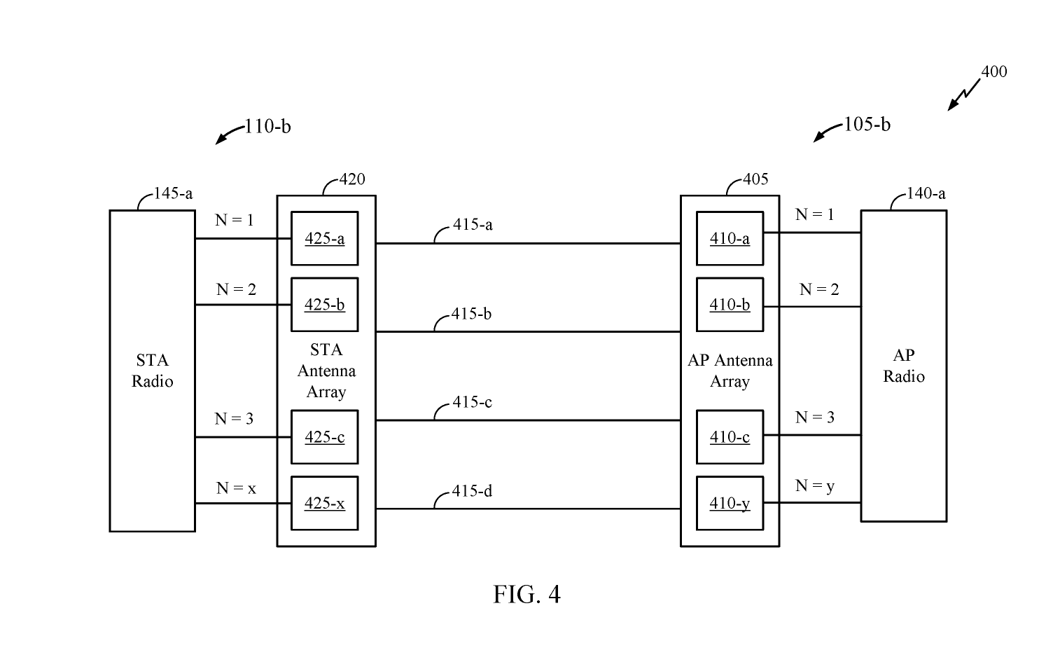

FIG. 4 shows a conceptual diagram of an example wireless communication system 400 operating with four spatial streams 415-a, 415-b, 415-c, and 415-d (collectively referred to herein as “spatial streams 415”), in accordance with various aspects of the present disclosure. A wireless device 110-b communicates with an access point 105-b over the spatial streams 415 according to a current bandwidth mode. The access point 105-b may be an example of one or more aspects of the AP 105 described with reference to FIGS. 1 and 3. The wireless device 110-b may be an example of one or more aspects of the wireless devices 110 described with reference to FIGS. 1 and 3.

The wireless device 110-b includes a station frequency agile radio 145-a and a STA antenna array 420. The STA frequency agile radio 145-a may be an example of one or more aspects of the STA frequency agile radio 145 of FIG. 1. The STA antenna array 420 may include a number, x, of antennas, including antennas 425-a, 425-b, 425-c, up to 425-x, wherein x can be any number of supported antennas. The wireless device 110-b also includes x number of receive chains N (where N can have integer values from 1 to x). For example, a receive chain N=1 is coupled to the antenna 425-a, a receive chain N=2 is coupled to the antenna 425-b, a receive chain N=3 is coupled to the antenna 425-c, and a receive chain N=x is coupled to the antenna 425-x.

Similarly, the AP 105-b includes an AP radio 140-a and an AP antenna array 405. The AP radio 140-a may be an example of one or more aspects of the AP frequency agile radio 140 of FIG. 1. The AP antenna array 405 may include a number, y, of antennas 410, including antennas 410-a, 410-b, 410-c, up to 410-y, wherein y can be any number of supported antennas. The AP 105-b also includes y number of receive chains N (where N can have integer values from 1 to y). For example, a receive chain N=1 is coupled to the antenna 410-a, a receive chain N=2 is coupled to the antenna 410-b, a receive chain N=3 is coupled to the antenna 410-c, and a receive chain N=y is coupled to the antenna 410-y. The numbers x and y may be the same number or different numbers.

The wireless device 110-b communicates with the AP 105-b over the four spatial streams 415. The wireless device 110-b and the AP 105-b may use the spatial streams for one or more channels. For example, the AP 105-b and the wireless device 110-b may use the 4 spatial streams for an 80 MHz channel for multi-user MIMO. In some examples, the four spatial steams may be used for different channel combinations.

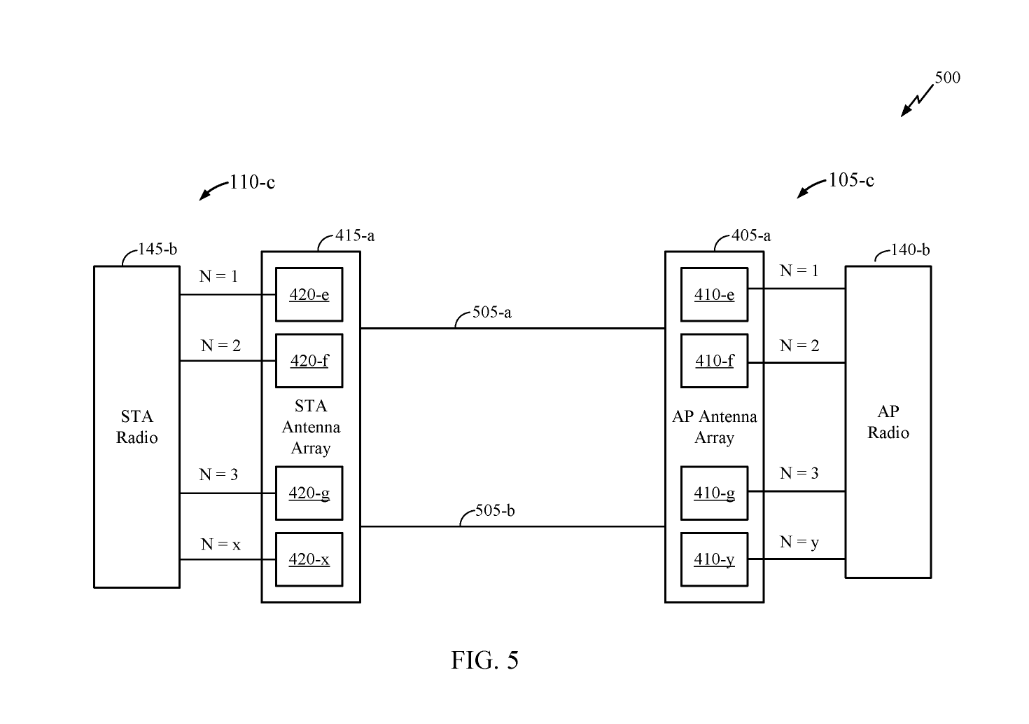

FIG. 5 shows a conceptual diagram 500 of an example wireless communication system operating with two spatial streams 505-a and 505-b (collectively referred to herein as “spatial streams 505”), in accordance with various aspects of the present disclosure. A wireless device 110-c communicates with an access point 105-c over the spatial streams 505 according to a current bandwidth mode. The access point 105-c may be an example of one or more aspects of the AP 105 described with reference to FIGS. 1 and 3-4. The wireless device 110-c may be an example of one or more aspects of the wireless devices 110 described with reference to FIGS. 1 and 3-4.

The wireless device 110-c includes a station frequency agile radio 145-b and a STA antenna array 420-a. The STA frequency agile radio 145-b may be an example of one or more aspects of the STA frequency agile radio 145 of FIGS. 1 and 4. The STA antenna array 420 may be an example of one or more aspects of the STA antenna array 420 of FIG. 4. The STA antenna array 420-a may include a number, x, of antennas 425, including antennas 425-e, 425-f, 425-g, up to 425-x, wherein x can be any number of supported antennas. The wireless device 110-c also includes x number of receive chains N.

Similarly, the AP 105-c includes an AP radio 140-b and an AP antenna array 405-a. The AP radio 140-b may be an example of one or more aspects of the AP frequency agile radio 140 of FIGS. 1 and 4. The AP antenna array 405-a may be an example of one or more aspects of the AP antenna array 405 of FIG. 4. The AP antenna array 405-a may include a number, y, of antennas 410, including antennas 410-e, 410-f, 410-g, up to 410-y, wherein y can be any number of supported antennas. The AP 105-b also includes y number of receive chains N.

The wireless device 110-c communicates with the AP 105-c over the two spatial streams 505. The wireless device 110-c and the AP 105-c may use the spatial streams for one or more channels. The number of spatial streams that the wireless device 110-c and the AP 105-c use may depend on the current bandwidth mode. For example, the AP 105-c and the wireless device 110-c may use the two spatial streams 505 for a 160 MHz channel. In examples where the wireless device 110-c and the AP 105-c may communicate over two or four spatial streams, four spatial streams in 80 MHz and two spatial streams in 160 MHz may be used by dedicating two chains to the lower 80 MHz segment and two chains to the upper 80 MHz segment.

In some examples, the AP 105-c and the wireless device 110-c may advertise support for different bandwidth modes by signaling a response frame including an operating mode notification (OMN) element. An OMN element transmitted by the AP 105-c may indicate, for example, that the AP 105-c is using the 80 MHz bandwidth mode or the 160 MHz bandwidth mode. The OMN element may also indicate a number of MIMO spatial streams supported by the AP 105-c. In some examples, including an OMN element in an association response frame does not imply that an OMN element needs to also be included in a beacon. This allows the OMN element to be targeted to a specific client wireless device, instead of all client wireless devices, as the OMN element would be if the OMN element were included in a beacon.

In some examples, the AP 105-c may support a 4 spatial stream 80 MHz channel and a 2 spatial stream 160 MHz channel at the same time. In such an example, the AP 105-c can transmit an operating mode notification (OMN) element in one or more association response frames to a 3 or 4 spatial stream 160 MHz supporting wireless device, such as the wireless device 110-c. For example, the AP 105-c may advertise itself as supporting 4 SS in a 160 MHz channel, but may avoid the use of 3-4 SS on 160 MHz channels modulation and coding schemes (MCSs) by setting the operating bandwidth to 80 MHz for 3-4 SS on 160 MHz clients, using the OMN element. In another example, the AP 105-c may avoid the use of 3 SS and 4 SS 160 MHz MCSs by using the OMN to set a maximum allowed number of spatial streams to two for wireless devices 110 that support 3 and 4 SS 160 MHz MCSs. This could be done in combination with an indication of a maximum data rate. Otherwise, a maximum data rate can be inferred. For example, the AP 105-c may set a maximum data rate of 1560 Mbps, otherwise the inferred maximum rate of the AP 105-c may be 3.5 Gbps. In other examples, other maximum data rates may be set or inferred.

In some examples, an OMN element may be mandatory on the receiver side for certification as a device conforming to the IEEE 802.11 ac standard. In some examples, the AP 105-c may alternatively create dual BSSs (with dual beacons). One BSS may use a 4 SS/80 MHz bandwidth mode while the other BSS may use a 2 SS/160 MHz bandwidth mode, for example. The two BSSs may use the same BSSID.

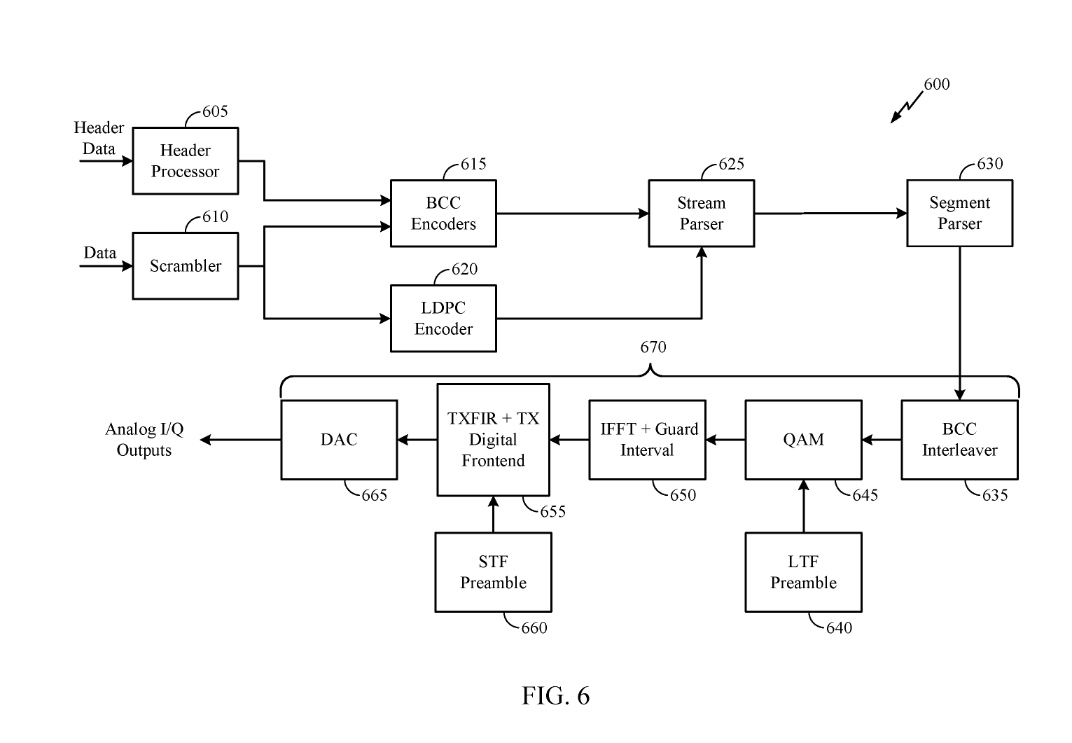

FIG. 6 shows a block diagram of an example digital portion of a physical layer of a transmitter 600, in accordance with various aspects of the present disclosure. The transmitter 600 may be included in an access point 105 or a wireless device 110, which may be an example of one or more aspects of the AP 105 or wireless device 110 described with reference to FIGS. 1 and 3-5, respectively. The components included in the transmitter 600 illustrate merely one example. In other examples, other components of the transmitter 600 may be used.

The transmitter 600 may receive, as inputs, header data into a header processor 605 and data into a scrambler 610. The header data may include control or other information for the data. The header processor 605 may interpret or otherwise process the header data and provide it to one or more binary convolutional code (BCC) encoders 615. The scrambler 610 may scramble (e.g., invert or encode) the data, in the analog or digital domain. The scrambler 610 may provide the scrambled data to the one or more BCC encoders 615 and a low-density parity check (LDPC) encoder 620.

The BCC encoder 615 and the LDPC encoder 620 may encode the scrambled data or the header data and provide the encoded data to a stream parser 625. The stream parser 625 may divide the received data into individual streams or segments. For example, the stream parser 625 may divide the received data into two streams for a 160 MHz bandwidth mode. The stream parser 625 may forward the divided data to a segment parser 630.

The segment parser 630 may divide bits of the received data between the two segments. An example functionality of the segment parser 630 is as follows. Per stream parser 625 output, the segment parser 630 takes blocks of N_{CBPSS} bits (i.e., coded bits per symbol per spatial stream) and may divide them over the segments. For example, the segment parser 630 may divide the blocks over two 80 MHz segments according to equation 1.

$${y}_{k , l} = {x}_{2 {sN}_{ES} ⌊ \frac{k}{{sN}_{ES}} ⌋ + {lsN}_{ES} + kmod ( {sN}_{ES} )} , k = 0 , 1 , … , \frac{{N}_{CBPSS}}{2} - 1 \qquad ( 1 )$$

As shown in equation 1, y_{k,l} is the output bit number k of frequency segment 1. The variable s is the number of coded bits per rail in the constellation mapping and may equal ceil

$$( \frac{{N}_{bpscs}}{2} ) ,$$

wherein N_{bpscs} may be me number of coded bits per subcarrier per stream. The variable N_{ES} may be the number of binary convolution encoder. In other words, the segment parser 630 may distribute the input data in chunks of 2sN_{ES} bits over segments, which may be done in a round-robin fashion. Note that the case that N_{CBPSS} is not divisible by 2sN_{ES} does not occur for one and two stream rates.

In an example of transmitting a contiguous 160 MHz channel with one synthesizer per segment, in order to deal with a third party receiver that is not capable of separate frequency offsets and timing-drift tracking per segment or channel tracking, a relative frequency error between the RF local oscillators (RFLOs) may be less than 0.005 ppm and a mismatch between the RFLOs and the sampling clock may be less than 0.005 ppm. This may be because an error vector magnitude (EVM) on an outer subcarrier of a 160 MHz transmission of 4 milliseconds (ms) due to the residual timing offset is limited and may be approximately given as in equation 2.

20 log₁₀(2π·80·10⁶·4·10⁻³·0.005·10⁻⁶)=−40 dBc (2)

In case of reception, if a third party transmitter does worse than above, the residual timing offset error due to a mismatch between the RFLO frequency and the sample rate may be corrected by separate frequency offset and timing-drift tracking per segment or channel tracking.

FIG. 6 shows the transmitter 600 including a single 80 MHz RF chain 670 for illustrative simplicity. However, the transmitter 600 may include more than one 80 MHz RF chain 670. For example, for each spatial stream at the 160 MHz bandwidth mode, after the segment parser 630, two 80 MHz segments may be processed by two 80 MHz RF chains 670, one for each segment, to create a single spatial stream of 160 MHz. In this manner, two spatial streams at 160 MHz may be supported with four 80 MHz RF chains 670.

The 80 MHz RF chain 670 may include a BCC interleaver 635, a long training field (LTF) preamble component 640, a QAM 645, a combination inverse fast Fourier Transform (IFFT) and guard interval (GI) component 650, a combination transmitter finite impulse response (TXFIR) and digital frontend component 655, a short training field preamble component 660, and a digital-to-analog converter (DAC) 665. The 80 MHz RF chain 670 outputs analog I/Q components, which may be provided to one or more antennas.

The combination TXFIR and digital frontend component 655 may include a number of sub-components. For example, the TXFIR plus digital frontend component 655 may include two or more transmitter digital frontend components, a combination beamforming or spatial expansion and cyclic shift diversity (CSD) component, a combination IFFT, GI, and low density parity check (LDPC) tone mapper component, a per transmitter CSD and phase component, a windowing component, an interpolator, a first transmitter FIR component, a first shift component, a digital clipping component, a transmitter gain component, a second FIR component, a second shift component, a digital pre-distortion (DPD) component, a local oscillator and IQ correction component, and a pre-emphasis component.

In one particular example, the interpolator component is a 10/11 interpolator 352 MHz mode component, the first FIR component is a 1×, 2×, 4×FIR component, the first shift component may shift the segments by 0, ±10, ±20, or ±30 MHz and may also duplicate the segments, the second FIR component is a 2×, 4×, 8×FIR component, and the second shift component may shift the segments 0, ±10, ±20, ±30, ±40, or ±45 MHz.

The combination TXFIR and digital frontend component 655 may include some changes over typical component configurations in order to support the 160 MHz bandwidth mode. In one example, these changes are used for the option that includes the ADCs at double the speed (e.g., 320 Msps). For example, the TXFIR may include additional coefficients for the 160 MHz channel. In some examples, the TXFIR of each segment may be sharp enough to keep any spillover to the other segment below an acceptable level, in order to reduce co-channel interference (CCI). At least one of the shift components (e.g., digital shifters) may be able to shift the segments by a greater number of MHz (e.g., 40 and 45). This additional digital frequency shift may be needed to support the 165 MHz bandwidth mode. The local oscillator and I/Q correction component may also include more taps for I/Q correction for a more accurate correction over a wider range (e.g., −85 to 85 MHz). A single user beamformer (SUBF) for 160 MHz may function as the beamformer for two TX per segment and up to 2 spatial streams.

In an example where the transmitting device (e.g., an AP 105 or wireless device 110) has four RF chains and four antennas, the two 80 MHz segments may be added after transmission from the antennas (i.e., in the air). In an example with four RF chains and two antennas, the two 80 MHz segments may be added after the RF chains.

In another example, if a wireless device 110 is permitted to begin a transmit opportunity (TXOP) and the wireless device 110 has at least one media access control (MAC) service data unit (MSDU) pending for transmission for the access category of the permitted TXOP, the wireless device 110 may perform only one of the following steps. In a first option, the wireless device 110 may transmit a 160 MHz or 80+80 MHz mask physical layer convergence protocol (PLCP) protocol data unit (PPDU) if the secondary channel, the secondary 40 MHz channel, and the secondary 80 MHz channel were idle during a point coordination function (PCF) interframe space (PIFS) interval immediately preceding the start of the TXOP. Alternatively, the wireless device 110 may transmit an 80 MHz mask PPDU on the primary 80 MHz channel if both the secondary channel and the secondary 40 MHz channel were idle during a PIFS interval immediately preceding the start of the TXOP. In another alternative, the wireless device 110 may transmit a 40 MHz mask PPDU on the primary 40 MHz channel if the secondary channel was idle during a PIFS interval immediately preceding the start of the TXOP. In yet another alternative, the wireless device 110 may transmit 20 MHz mask PPDU on the primary 20 MHz channel. Finally, the wireless device 110 may restart the channel access attempt by invoking a backoff procedure.

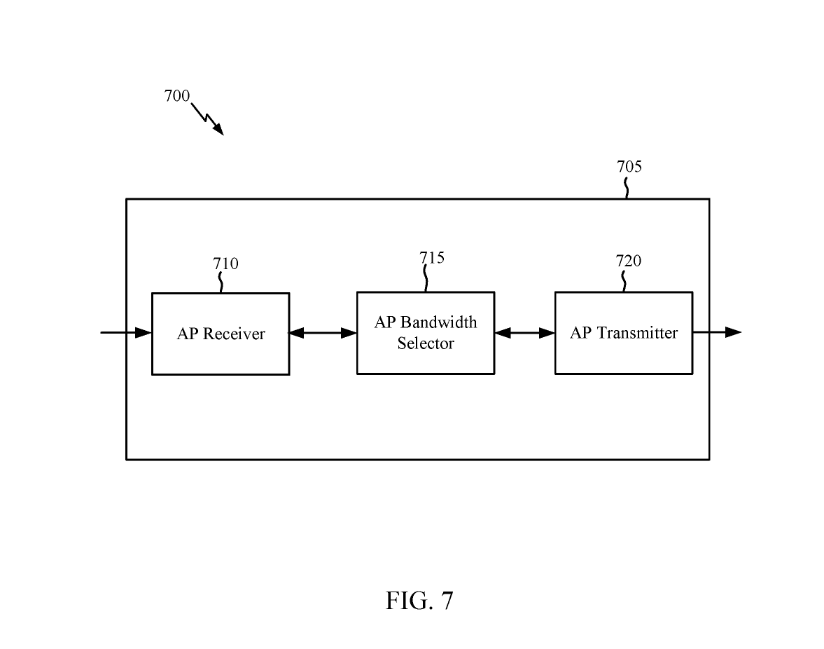

FIG. 7 shows a block diagram 700 of a wireless device 705 for use in an AP for wireless communication, in accordance with various aspects of the present disclosure. The wireless device 705 may be an example of one or more aspects of an AP 105 described with reference to FIGS. 1 and 3-5. The wireless device 705 may include a receiver 710, an AP bandwidth selector 715, and/or a transmitter 720. The wireless device 705 may also be or include a processor. Each of these components may be in communication with each other.

The wireless device 705, through the receiver 710, the AP bandwidth selector 715, or the transmitter 720, may be configured to perform functions described herein. For example, the wireless device 705 may be configured to operate in one or more bandwidth modes, including a 20, 40, 80, 80+80, 160 contiguous, and 165 MHz bandwidth modes.

The components of the wireless device 705 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The receiver 710 may receive information such as packets, user data, and/or control information associated with various information channels (e.g., control channels, data channels, etc.). The receiver 710 may be configured to receive one or more data packets at 160 MHz or 165 MHz, for example. Information may be passed on to the AP bandwidth selector 715, and to other components of the wireless device 705.

In some examples, the AP receiver 710 may include some features in order to support the 160 MHz bandwidth mode. In some examples, the sampling rate of an ADC of the AP receiver 710 may be increased (e.g., doubled) to 320 Msps and the ADC has a bitwidth of 10 bits. An extrapolated initial frequency offset estimate on a primary 20 MHz channel may be applied to a secondary 80 MHz channel starting from a first VHT-LTF symbol. The AP receiver 710 may also be capable of independent phase, frequency, and timing-drift tracking per segment. A channel estimator may perform two different two spatial stream channel estimates. The AP receiver 710 may also include two 2×2 QR decomposition (QRD) components and a MIMO decoder. In some examples, the AP receiver 710 includes two MIMO decoders, one per segment. The AP receiver 710 may also perform segment deparsing (e.g., the inverse of segment parsing at the transmitter) before stream deparsing. The AP receiver 160 may also support radar detection for 160 MHz.

The AP receiver 710 may also include an automatic front end (AFE) component in order to perform automatic gain control (AGC). The automatic gain control may be performed per chain or per segment. Further, a receiver finite impulse response (FIR) filter (RXFIR) for one segment may be sharp enough to suppress the adjacent channel interference (ACI) of another segment, where the Fast Fourier Transform (FFT) is oversampled by a factor of two.

Detection for the AGC may be done with all four receive antennas on the primary segment. Some delay may be introduced by adding an additional RXFIR. Power estimates for the ADC may be performed at 320 MHz.

After the AP receiver 710 detects an 160 MHz packet, the wireless device 705 switches to the 2×2 mode during very high throughput short training field (VHT-STF) by changing frequency shift on input of 2 chains from −40 to +40 MHz if the primary 20 MHz channel is in a lower segment or from +40 to −40 MHz if the primary 20 MHz channel is in an upper segment. For example, these are the cases where a carrier frequency is −40 MHz from the center of the upper segment or +40 MHz from the center of the lower segment, respectively. Alternatively, the frequency shifts may be static, but the proper first FIR output is selected. For example, for the 160 MHz bandwidth mode, two digital backend chains may select a first FIR FFT/TDC ext80 MHz output, while the other backend chains stay with the primary 80 MHz output. The frequency shifts may also be +45 MHz, −45 MHz, +42.5 MHz, or -42.5 MHz

The wireless device 705 may also support different listen and detection modes. That is, the wireless device 705 may monitor or listen for traffic using bandwidth modes. Dynamic switching may be used to during VHF-STF to switch between a given listen mode and a detection mode.

In some examples capable of supporting the 165 MHz bandwidth mode, the AP receiver 710 may use an 80+80 MHz spectral mask. For example, if the transmitter local oscillator is at 5732.5 MHz, each 80 MHz spectrum may have a level of about 20.3 dBr, which combined may allow a level of about −17.3 dBr for the transmit local oscillator (TXLO). In some examples, the TXLO may be anywhere between 5730 through 5735 MHz, which may require a level of −10 dBr. In other examples, other frequencies for the TXLO may be used.

For channel estimation and compressed beamforming feedback, the AP receiver 710 may include a channel estimation block that supports two spatial stream 80 MHz channel estimates (i.e., one per segment). For VHT160, a VHT compressed beamforming feedback matrix subfield of a VHT compressed beamforming feedback report field may consist of the (grouped) tones of the lower and upper segment (which may be ordered from most left tone in frequency domain to most right tone). In one example, the AP receiver includes two 2×2 80 MHz singular value decomposition (SVD) components. For MU feedback, a delta SNR in a VHT MU exclusive beamforming report field is computed with respect to the average SNR (or average channel power) over all tones (i.e., not per segment).

In some examples, the AP receiver 710 may not support implicit beamforming in an 80+80 MHz bandwidth mode, but may support implicit beamforming for STAs that operate according to bandwidth modes of 80 MHz or less. If in the 80+80 MHz bandwidth mode the default listen mode uses three receive chains on a primary 80 MHz channel and three receive chains on a secondary 80 MHz channel, implicit beamforming channel estimates on L-LTFs from the STA may not be received over the optimal four receive chains.

To address this issue, the MAC layer of the AP receiver 710 may determine when an acknowledgement (ACK) message with a bandwidth of 80 MHz or less is expected from the STA. When such an ACK message is expected, the MAC layer of the AP receiver 710 may signal to the PHY layer to adjust the number of receive chains used for the primary 80 MHz channel (e.g., from three receive chains to four receive chains) to allow for implicit beamforming channel estimates to be performed on the desired number of receive chains. This signaling may be via a management message from the MAC layer to the PHY layer. The management message may indicate the number of receive chains to allocate to the listening mode of the primary 80 MHz channel (e.g., four receive chains). Alternatively, the management message may indicate a number of frequency segments for the listen mode, with an explicit or implicit message that a certain number of receive chains (e.g., four) is to be tuned to the first frequency segment and the remainder of the receive chains (e.g., two) is to be tuned to the second frequency segment.

The AP receiver 710 may also perform frequency offset estimation and pilot tracking. A 160 MHz device, for example, may use a separate phase-locked-loop (PLL) per segment, which may cause phase noise variations between the segments that must be tracked separately. If a third part transmitter sends 160 MHz as 80+80 MHz with two RFLOs, there may be a risk of inaccuracy between the segment dividers in generating the two RFLOs. In such a case, the AP receiver 710 may perform separate frequency and timing tracking per segment in addition to separate phase tracking per segment.

In some examples, the inaccuracy between the segment dividers may not be bad to warrant a separate initial frequency offset estimate on the secondary 80 MHz channel, so the AP receiver 710 may extrapolate the initial frequency offset estimate on the primary 20 MHz channel to apply it on the secondary 80 MHz channel starting from a first VHT Long Training Field (VHT-LTF) symbol. An example frequency offset is provided in equation 3, where f_{center,s80} and f_{center,p20} are the center RF frequency of the secondary 80 MHz channel and the primary 20 MHz channel, respectively.

$${f}_{off , s 80} = {f}_{off , p 20} \frac{{f}_{center , s 80}}{{f}_{center , p 20}} \qquad ( 3 )$$

In some examples, pilot tracking per segment may be the same as a typical 80 MHz pilot tracking with the understanding that the carrier frequency per segment is in the middle of the corresponding segment. In some examples, separate timing drift per segment is possible.

The AP receiver 710 may also include two 2×2 QRD components and MIMO decoders, one per segment. In some examples, the AP receiver 710 may alternatively map the two spatial stream 160 MHz channel onto a four spatial stream 80 MHz MIMO decoder. That is, the two spatial streams may be combined onto the two 80 MHz segments to four spatial streams using a block diagonal channel matrix with the two 2×2 segment channel matrices on the diagonal.

The following describes a way to use a 4×4 MIMO decoder for two 2×2 MIMO decoding. If y_{i,p80}(k) represents the i^{th} RX signal on the k^{th} subcarrier of the primary 80 MHz segment and y_{i,s80}(k) that of the secondary 80 MHz segment, x_{i,p80}(k) and x_{i,s80}(k) the respective TX signals, and Hₚ₈₀(k) and Hₛ₈₀(k) the 2×2 MIMO channels, then this may be combined (omitting subcarrier index k) in a 4×4 equation as shown in equation 4.

$$( \begin{matrix}{y}_{1 , p 80} \\ {y}_{2 , p 80} \\ {y}_{1 , s 80} \\ {y}_{2 , s 80}\end{matrix} ) = ( \begin{matrix}{h}_{11 , p 80} & {h}_{12 , p 80} & 0 & 0 \\ {h}_{21 , p 80} & {h}_{22 , p 80} & 0 & 0 \\ 0 & 0 & {h}_{11 , s 80} & {h}_{12 , s 80} \\ 0 & 0 & {h}_{21 , s 80} & {h}_{22 , s 80}\end{matrix} ) ( \begin{matrix}{x}_{1 , p 80} \\ {x}_{2 , p 80} \\ {x}_{1 , s 80} \\ {x}_{2 , s 80}\end{matrix} ) \qquad ( 4 )$$

Doing the QR decomposition on above block diagonal 4×4 channel matrix results in equation 5.

$$\begin{matrix}QR = qr ( ( \begin{matrix}{h}_{11 , p 80} & {h}_{12 , p 80} & 0 & 0 \\ {h}_{21 , p 80} & {h}_{22 , p 80} & 0 & 0 \\ 0 & 0 & {h}_{11 , s 80} & {h}_{12 , s 80} \\ 0 & 0 & {h}_{21 , s 80} & {h}_{22 , s 80}\end{matrix} ) ) \\ = ( \begin{matrix}{q}_{11 , p 80} & {q}_{12 , p 80} & 0 & 0 \\ {q}_{21 , p 80} & {q}_{22 , p 80} & 0 & 0 \\ 0 & 0 & {q}_{11 , s 80} & {q}_{12 , s 80} \\ 0 & 0 & {q}_{21 , s 80} & {q}_{22 , s 80}\end{matrix} ) \\ ( \begin{matrix}{r}_{11 , p 80} & {r}_{12 , p 80} & 0 & 0 \\ 0 & {r}_{22 , p 80} & 0 & 0 \\ 0 & 0 & {r}_{11 , s 80} & {r}_{12 , s 80} \\ 0 & 0 & 0 & {r}_{22 , s 80}\end{matrix} )\end{matrix} \qquad ( 5 )$$

From equation 5, the QR decomposition may not change the property that the two 2×2 MIMO equations are independent. This may allow for independent frequency and phase tracking per 80 MHz segment. In some situations, parts of the 4×4 MIMO processing that are not being used may be disabled to save power.

The AP receiver 710 may perform radar detection over the selected bandwidth. In one example, the AP receiver 710 may perform radar detection separately on the primary and secondary segments. Alternatively, the AP receiver 710 may increase radar FFTs by 2 as well as the clock speed of the other processing elements. For example, a short FFT may be doubled from 128 to 256 points and a regular FFT may be doubled from 512 to 1024 points. These FFTs may be reused for round trip time (RTT) and spectral scanning. In some examples, only one segment needs to do radar detection for the lowest 160 MHz channel and the 160 MHz bandwidth mode. In some examples, the radar detection hardware may be run at the ADC rate while the software performs any filtering.

If fine timing measurements (FTMs) are sent in VHT160 format, the AP receiver 710 may perform 80+80 MHz RTT processing using the channel estimates on the VHT-LTFs. For legacy octuplicate (i.e., duplicate160) frames, the AP receiver 710 may use the primary 80 MHz channel only (because no L-LTF channel estimation is done on the secondary 80 MHz channel). In some examples, 160 MHz RTT processing may not be possible because the VHT channel estimates of each segment come from different receive antennas. The 160 MHz RTT or the 80+80 RTT may require the AP receiver 710 to include extra 80 MHz chains (e.g., at least up to and including the channel estimation) to make sure that on at least two receive antennas is obtained to get an 80 MHz channel estimate (e.g., one receive antenna on the primary 80 MHz channel and one receive antenna on the secondary 80 MHz channel).

In some examples, the wireless device 705 may correct for potential phase discontinuities in legacy duplicate40/80/160 packets between 20 MHz sub-channels at the transmitter 720 and between the primary 80 MHz channel and the secondary 80 MHz channel at both the transmitter 720 and the receiver 710. A management message indicates the listening mode to a physical (PHY) layer. In some examples, the management message may be a media access control (MAC) message. The receiver may be reconfigured based on an expected data packet type that may be conveyed in the management message. For example, the configuration of the receiver 710 may be adjusted in order that the receiver 710 may be capable of receiving an expected data packet type based on the management message.

The AP bandwidth selector 715 may switch the wireless device 705 between operating in one or more bandwidth modes, including a 20, 40, 80, 80+80, 160 contiguous, and 165 MHz bandwidth modes. The AP bandwidth selector 715 may cause the wireless device 705 to advertise support by a wireless device for the different bandwidth modes. The AP bandwidth selector 715 may also adjust the number of MIMO spatial streams currently used by the wireless device 705 in response to the selected bandwidth mode.

The AP transmitter 720 may be one or more aspects of the transmitter 600 of FIG. 6. The AP transmitter 720 may transmit the one or more signals received from other components of the wireless device 705, for example, a bandwidth support message 305. The AP transmitter 720 may include components that enable channel bonding between a plurality of channels. The AP transmitter 720 may transmit one or more data packets at 160 MHz or 165 MHz, for example. In some examples, the AP transmitter 720 may be collocated with the receiver 710 in a transceiver.

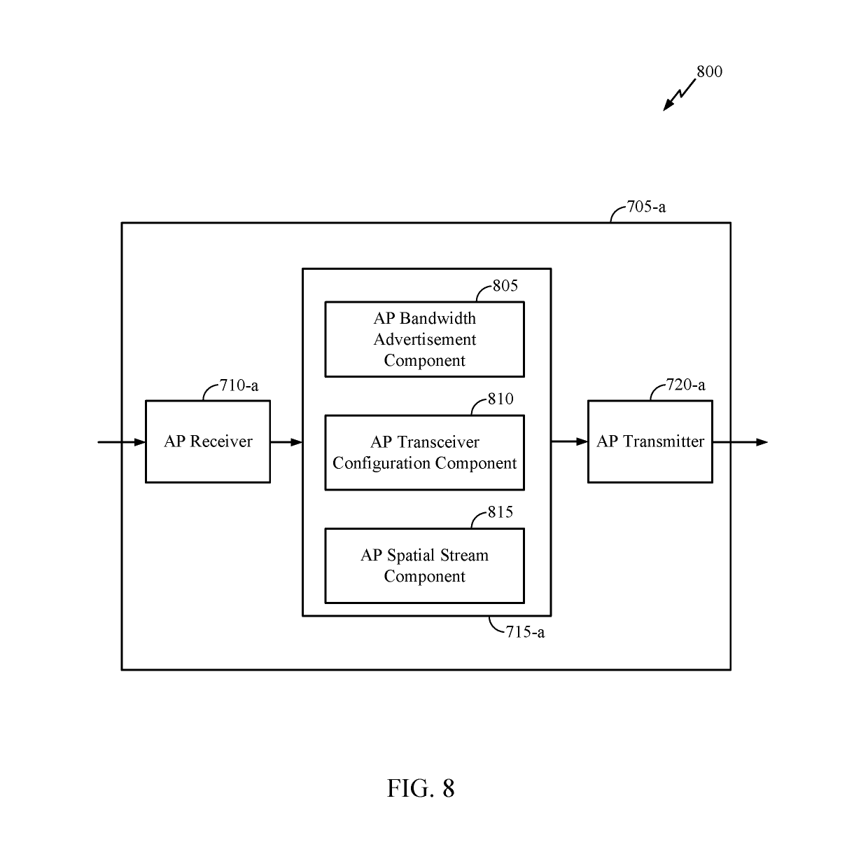

FIG. 8 shows a block diagram 800 of a wireless device 705-a that is used in an AP for wireless communication, in accordance with various examples. The wireless device 705-a may be an example of one or more aspects of the APs 105 described with reference to FIGS. 1 and 3-5. It may also be an example of a wireless device 705 described with reference to FIG. 7. The wireless device 705-a may include an AP receiver 710-a, AP bandwidth selector 715-a, or an AP transmitter 720-a, which may be examples of the corresponding modules of the wireless device 705. The wireless device 705-a may also include a processor. Each of these modules may be in communication with each other. The AP bandwidth selector 715-a may include an AP bandwidth advertisement component 805, an AP transceiver configuration component 810, and an AP spatial stream component 815. The AP receiver 710-a and the AP transmitter 720-a may perform the functions of the AP receiver 710 and the AP transmitter 720, of FIG. 7, respectively.

The components of the wireless device 705-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The AP bandwidth advertisement component 805 causes the wireless device 705-a to send bandwidth support messages to one or more client wireless devices 110 and other APs 105. The AP bandwidth advertisement component 805 may also interpret a bandwidth support message received at the AP receiver 710-a. Based on an identified bandwidth in the bandwidth support message, the AP bandwidth selector 715-a may select a current bandwidth mode to match the identified bandwidth.

The AP transceiver configuration component 810 may update the AP receiver 710-a or the transmitter 720-a based on the selected bandwidth mode. The AP spatial stream component 815 may adjust the MIMO spatial streams used based on the selected bandwidth mode.

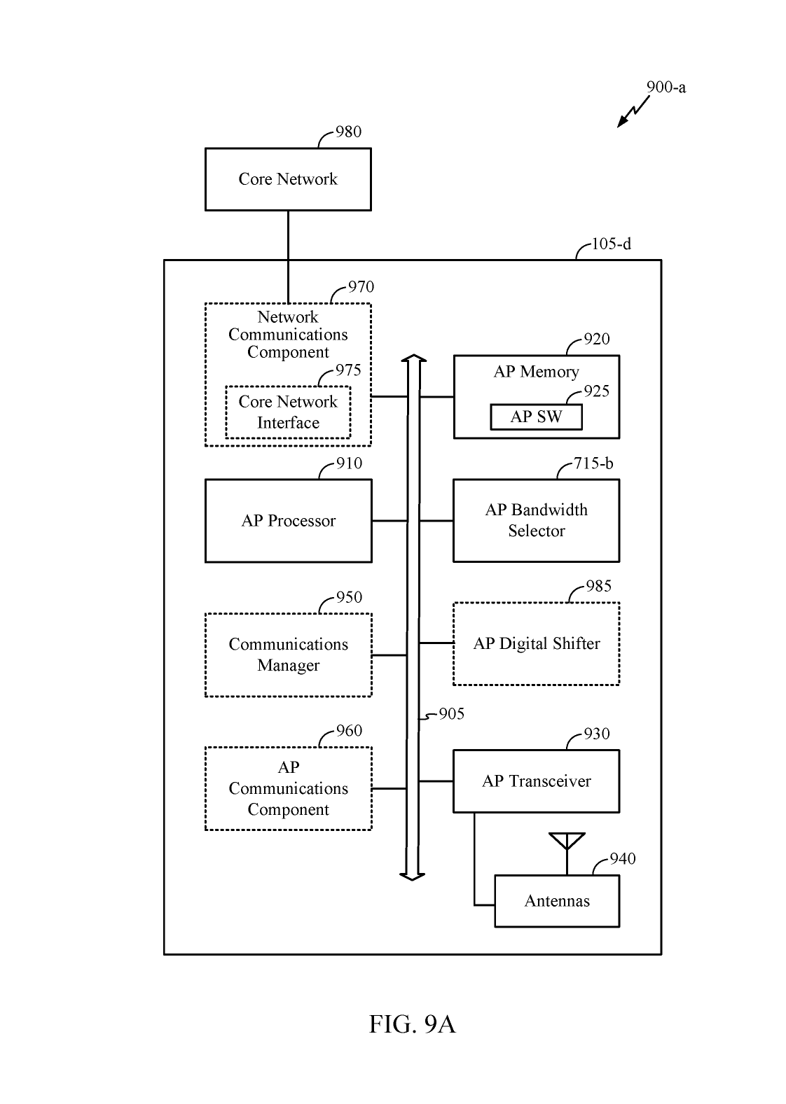

Turning to FIG. 9A, a diagram 900-a is shown that illustrates an access point or AP 105-d configured for operating in one or more bandwidth modes, including an 80+80, 160 contiguous, and 165 MHz bandwidth modes. In some aspects, the AP 105-d may be an example of the APs 105 of FIGS. 1 and 3-5. The AP 105-d may include an AP processor 910, an AP memory 920, an AP transceiver 930, antennas 940, and an AP bandwidth selector 715-b. The AP bandwidth selector 715-b may be an example of the AP bandwidth selector 715 of FIGS. 7 and 8. In some examples, the AP 105-d may also include one or both of an AP communications manager 950, an AP communications component 960, and an AP network communications component 970. The AP network communications component 970 may further include an AP code network interface 975. Each of these components may be in communication with each other, directly or indirectly, over at least one interface 905, which may be a bus.

The AP memory 920 may include random access memory (RAM) and read-only memory (ROM). The AP memory 920 may also store computer-readable, computer-executable software (SW) code 925 containing instructions that are configured to, when executed, cause the AP processor 910 to perform various functions described herein for using different bandwidth modes such as the 80+80, 160, and 165 MHz bandwidth modes, for example. Alternatively, the software code 925 may not be directly executable by the AP processor 910 but be configured to cause the computer, e.g., when compiled and executed, to perform functions described herein.

The AP processor 910 may include an intelligent hardware device, e.g., a central processing unit (CPU), a microcontroller, an ASIC, and the like. The AP processor 910 may process information received through the AP transceiver 930, the AP communications component 960, and/or the AP network communications component 970. The AP processor 910 may also process information to be sent to the AP transceiver 930 for transmission through the antennas 940, to the AP communications component 960, and/or to the AP network communications component 970. The AP processor 910 may handle, alone or in connection with the AP bandwidth selector 715-b, various aspects related to channel bonding to support 80+80, 160, and 165 MHz bandwidth modes.

The AP transceiver 930 may include a modem configured to modulate the packets and provide the modulated packets to the antennas 940 for transmission, and to demodulate packets received from the antennas 940. The AP transceiver 930 may be implemented as at least one transmitter module and at least one separate receiver module. The AP transceiver 930 may be configured to communicate bi-directionally, via the antennas 940, with at least one wireless device 110 as illustrated in FIGS. 1, 3, and 4, for example. The AP 105-d may typically include multiple antennas 940 (e.g., an antenna array). The AP 105-d may communicate with an AP core network 980 through the AP network communications component 970. The AP 105-d may communicate with other APs as well, using an AP communications component 960.

According to the architecture of FIG. 9A, the AP 105-d may further include an AP communications manager 950. The AP communications manager 950 may manage communications with stations and/or other devices as illustrated in the WLAN network 100 of FIG. 1. The AP communications manager 950 may be in communication with some or all of the other components of the AP 105-d via the interface or interfaces 905. Alternatively, functionality of the AP communications manager 950 may be implemented as a component of the AP transceiver 930, as a computer program product, and/or as at least one controller element of the AP processor 910.

The AP 105-d may further include a digital shifter 785. The digital shifter 785 may shift frequencies of one or more channels or chains, such as by ±40 or 45 MHz. In some examples, the digital shifter 785 is part of the AP transceiver 930.

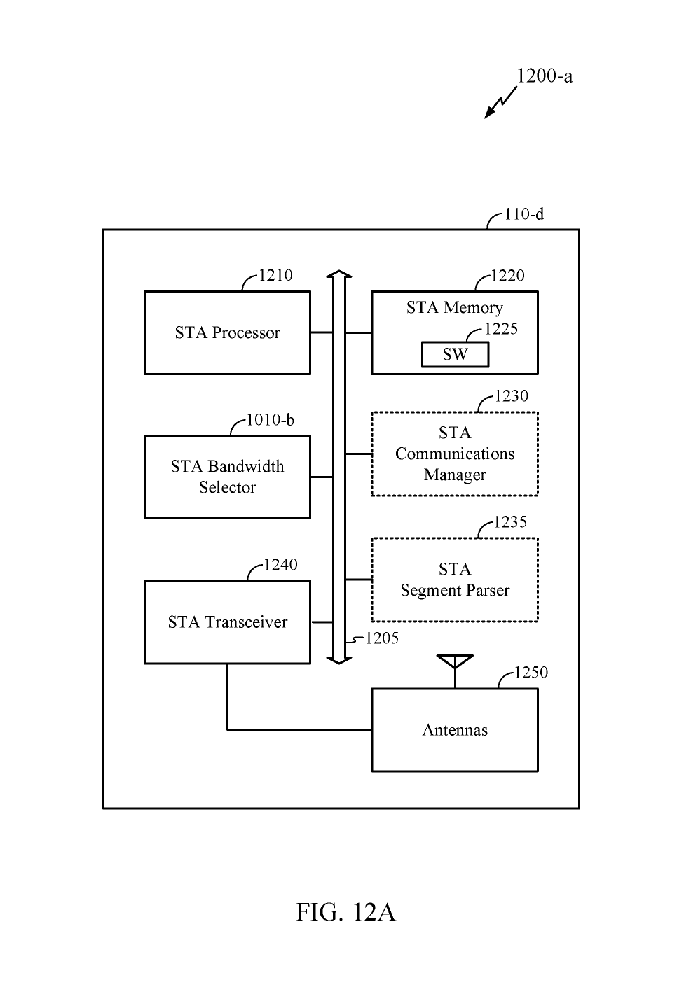

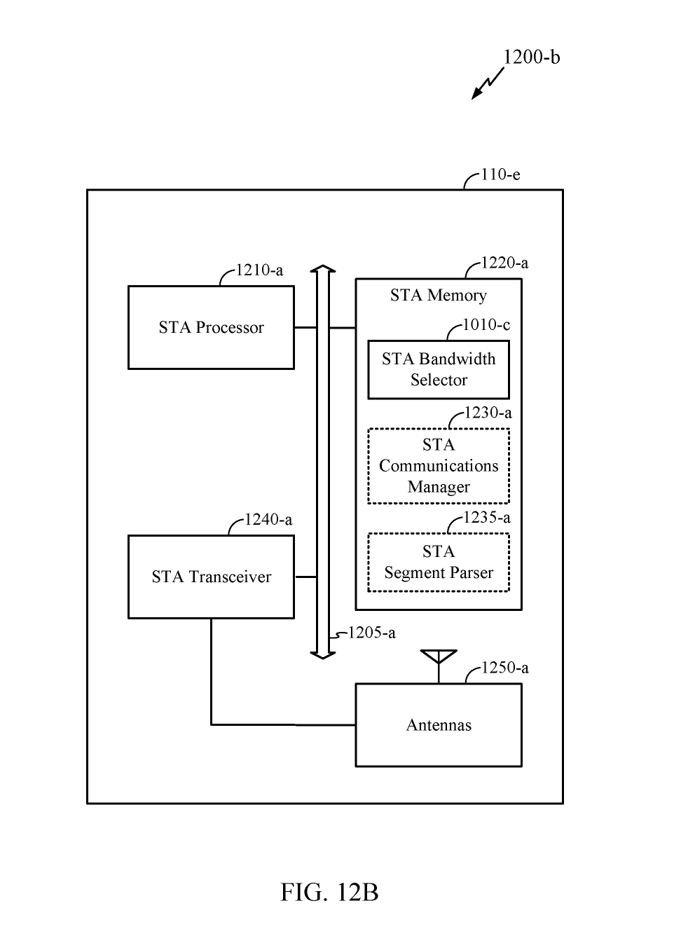

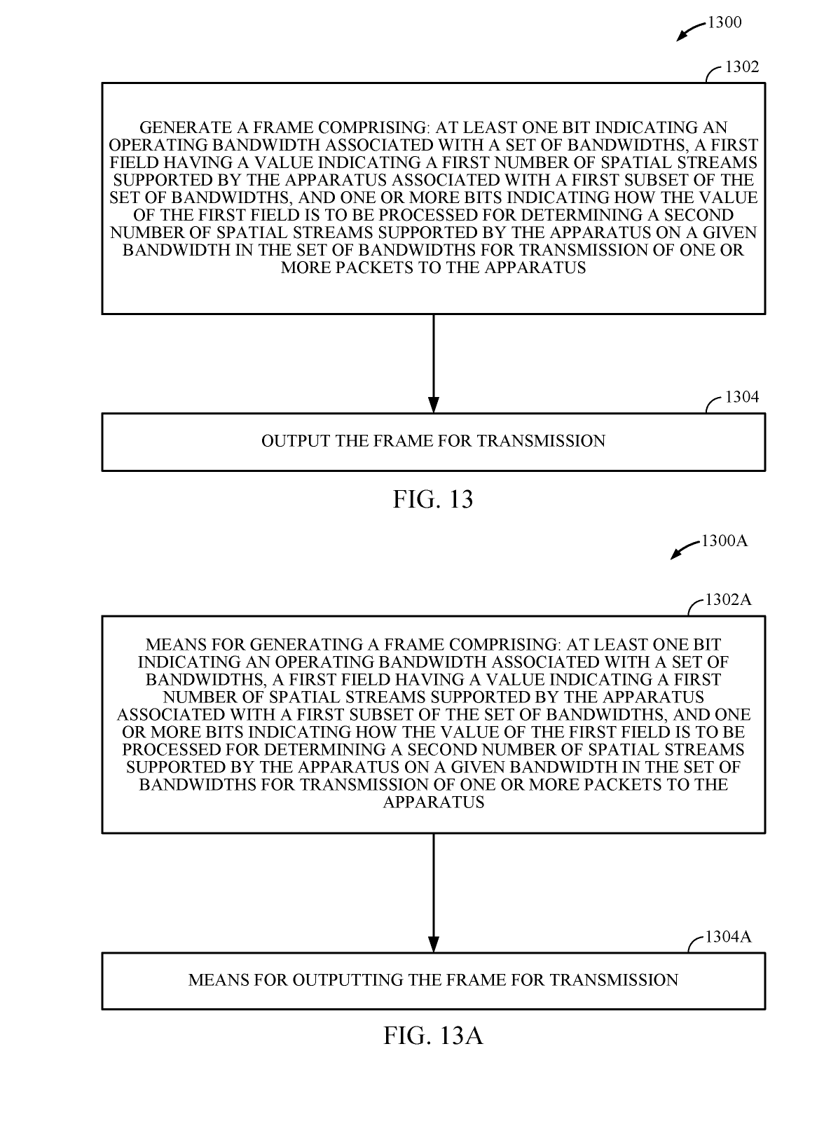

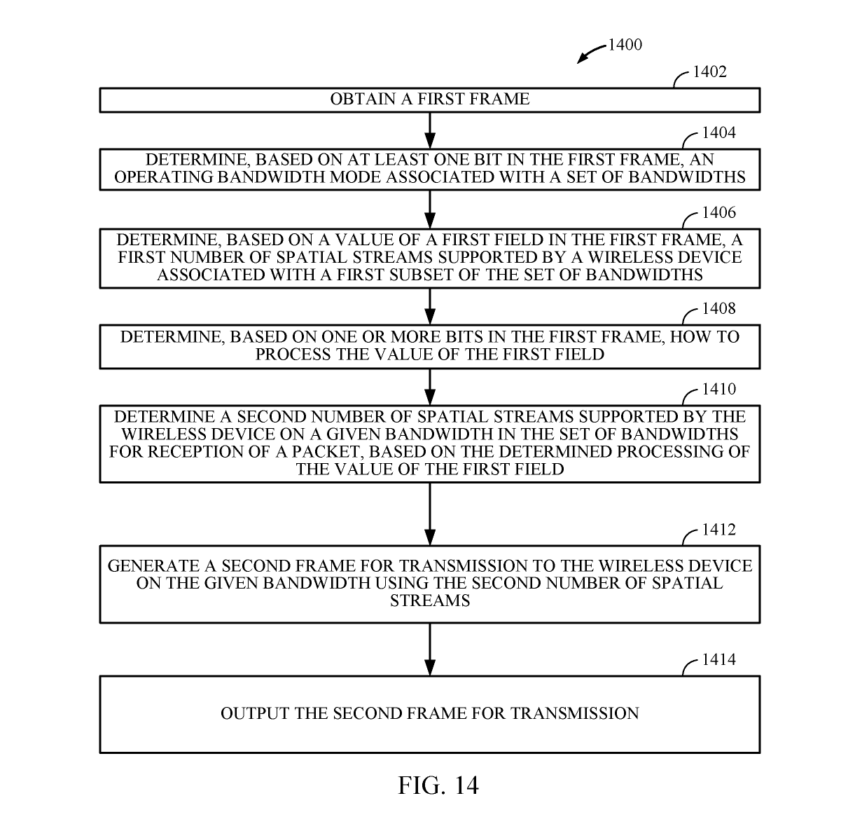

The components of the AP 105-d may be configured to implement aspects discussed above with respect to FIGS. 1-8, and those aspects may not be repeated here for the sake of brevity. Moreover, the components of the AP 105-d may be configured to implement aspects discussed below with respect to FIGS. 13 and 14 and those aspects may not be repeated here also for the sake of brevity.

Turning to FIG. 9B, a diagram 900-b is shown that illustrates an access point or AP 105-e configured for operating in one or more bandwidth modes, including an 80+80, 160 contiguous, and 165 MHz bandwidth modes. In some aspects, the AP 105-e may be an example of the APs 105 of FIGS. 1, 3-5, and 9A. Similar to the AP 105-d of FIG. 9A, the AP 105-e may include an AP processor 910-a, an AP memory 920-a, an AP transceiver 930-a, antennas 940-a, and an AP bandwidth selector 715-c, which may perform the functions of the corresponding components in FIG. 9A. The AP bandwidth selector 715-c may be an example of the AP bandwidth selector 715 of FIGS. 7-9A. In some examples, the AP 105-e may also include one or both of an AP communications manager 950-a, an AP communications component 960-a, and an AP network communications component 970-a, which may perform the functions of the corresponding components in FIG. 9A. The AP network communications component 970-a may further include an AP code network interface 975-a. Each of these components may be in communication with each other, directly or indirectly, over at least one interface 905-a.

The example of FIG. 9B illustrates the AP bandwidth selector 715-a, an AP digital shifter 938-a, the AP communications manager 950-a, and the AP communications component 960-a as software stored in the AP memory 920-a. The AP memory 920-a may store these components as computer-readable, computer-executable software code containing instructions that are configured to, when executed, cause the AP processor 910-a to perform various functions described herein for using different bandwidth modes such as the 80+80, 160, and 165 MHz bandwidth modes, for example. Alternatively, the AP bandwidth selector 715-a, the AP digital shifter 938-a, the AP communications manager 950-a, and the AP communications component 960-a may not be directly executable by the AP processor 910-a but may be configured to cause the computer, e.g., when compiled and executed, to perform functions described herein.

The components of the AP 105-e may be configured to implement aspects discussed above with respect to FIGS. 1-8 and 9A, and those aspects may not be repeated here for the sake of brevity. Moreover, the components of the AP 105-e may be configured to implement aspects discussed below with respect to FIGS. 13 and 14 and those aspects may not be repeated here also for the sake of brevity.

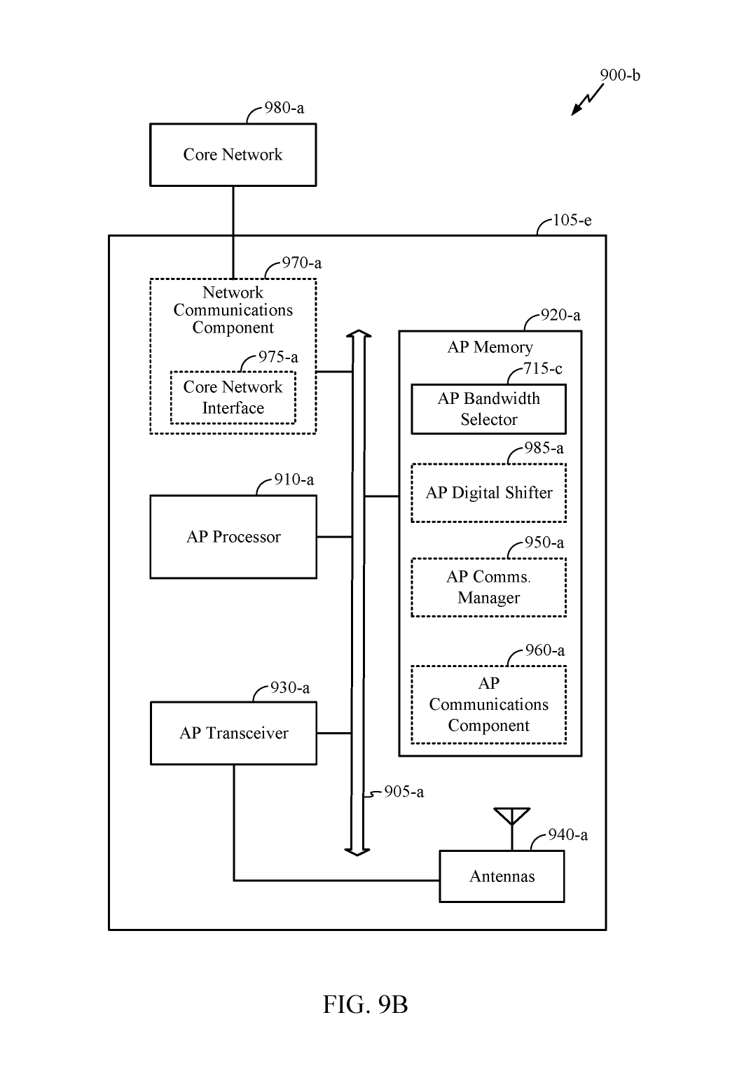

FIG. 10 shows a block diagram 1000 of a wireless device 1005 for use in a station for wireless communication, in accordance with various aspects of the present disclosure. In some examples, the wireless device 1005 may be an example of aspects of one or more of the wireless devices 110 described with reference to FIGS. 1 and 3-5. The wireless device 1005 may also be or include a processor. The wireless device 1005 may include a STA receiver 1010, a STA bandwidth selector 1015, or a STA transmitter 1020. Each of these modules may be in communication with each other.

The wireless device 1005, through the STA receiver 1010, the STA bandwidth selector 1015, or the STA transmitter 1020, may be configured to perform functions described herein. For example, the wireless device 1005 may be configured to perform various aspects related to channel bonding to support 80+80, 160, and 165 MHz bandwidth modes.

The components of the wireless device 1005 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

The STA receiver 1010 may receive information such as packets, user data, or control information associated with various information channels (e.g., control channels, data channels, etc.). The STA receiver 1010 may be configured to receive data packets over various frequencies and bandwidth support messages. Information may be passed on to the STA bandwidth selector 1015, and to other components of the wireless device 1005.

The STA bandwidth selector 1015 may be configured to implement aspects discussed above with respect to the AP bandwidth selector 715 of FIGS. 7-9, and those aspects may not be repeated here for the sake of brevity.

The STA transmitter 1020 may transmit the one or more signals received from other components of the wireless device 1005. The STA transmitter 1020 may transmit data packets over various frequencies and bandwidth support messages. In some examples, the STA transmitter 1020 may be collocated with the STA receiver 1010 in a transceiver. The STA transmitter 1020 may include a single antenna, or it may include a plurality of antennas.

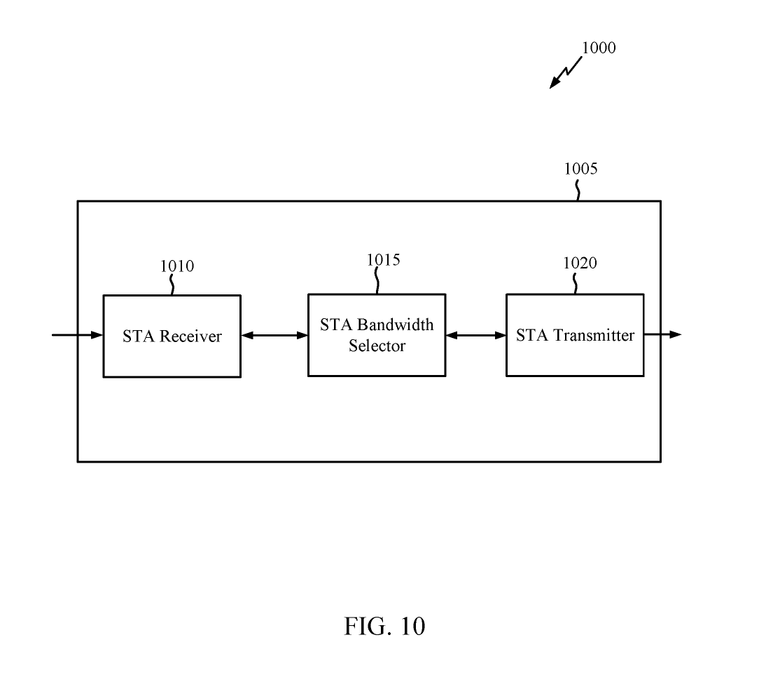

FIG. 11 shows a block diagram 1100 of a wireless device 1005-a that is used in a wireless device for wireless communication, in accordance with various examples. The wireless device 1005-a may be an example of one or more aspects of a wireless device 110 described with reference to FIGS. 1 and 3-5. It may also be an example of a wireless device 1005 described with reference to FIG. 10. The wireless device 1005-a may include a STA receiver 1010-a, a STA bandwidth selector 1015-a, or a STA transmitter 1020-a, which may be examples of the corresponding modules of wireless device 1005. The wireless device 1005-a may also include a processor. Each of these components may be in communication with each other. The STA bandwidth selector 1015-a may include a STA bandwidth advertisement component 1105, a STA transceiver configuration component 1110, and a STA spatial stream component 1115. The STA receiver 1010-a and the STA transmitter 1020-a may perform the functions of the STA receiver 1010 and the STA transmitter 1020, of FIG. 10, respectively.

The STA bandwidth advertisement component 1105, the STA transceiver configuration component 1110, and the STA spatial stream component 1115 may be configured to implement aspects discussed above with respect to the AP bandwidth advertisement component 805, the AP transceiver configuration component 810, and the AP spatial stream component 815 of FIG. 8, and those aspects may not be repeated here for the sake of brevity.

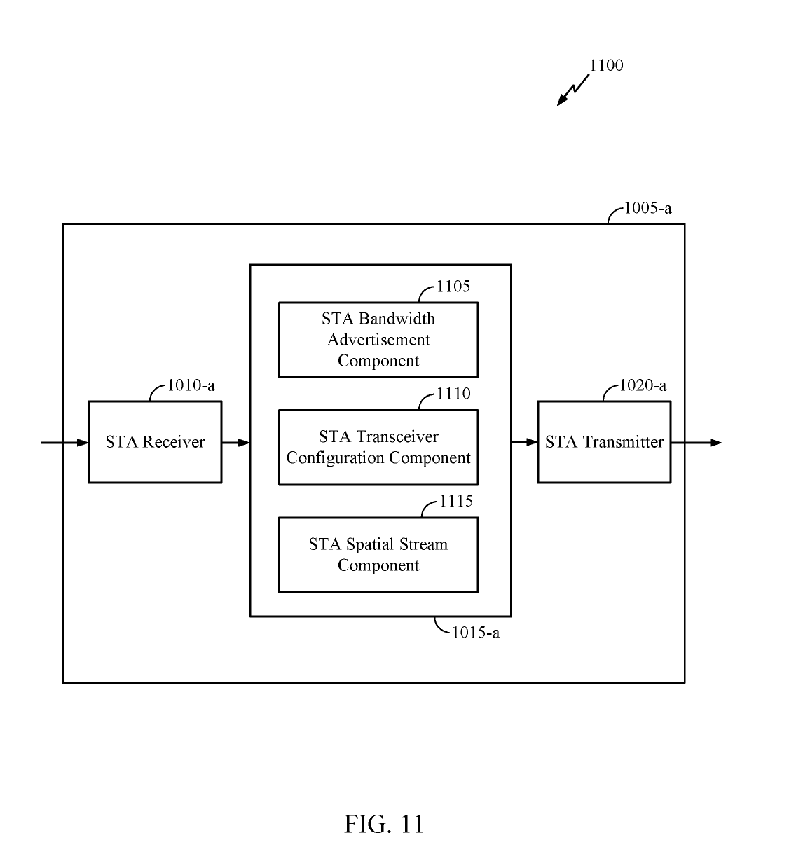

Turning to FIG. 12A, a diagram 1200-a is shown that illustrates a wireless device 110-d configured for operating in multiple bandwidth modes, including a 20, 40, 80, 80+80, 160, and 165 MHz bandwidth modes. The wireless device 110-d may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, and the like. The wireless device 110-d may have an internal power supply, such as a small battery, to facilitate mobile operation. The wireless device 110-d may be an example of the wireless devices 110 of FIGS. 1 and 3-5.

The wireless device 110-d may include a STA processor 1210, a STA memory 1220, a STA transceiver 1240, antennas 1250, and a STA bandwidth selector 1015-b. The STA bandwidth selector 1015-b may be an example of the STA bandwidth selector 1015 of FIGS. 10 and 11. Each of these components may be in communication with each other, directly or indirectly, over at least one interface 1205, which may be a bus.

The STA memory 1220 may include RAM and ROM. The STA memory 1220 may store computer-readable, computer-executable software (SW) code 1225 containing instructions that are configured to, when executed, cause the STA processor 1210 to perform various functions described herein for channel bonding. Alternatively, the software code 1225 may not be directly executable by the STA processor 1210 but be configured to cause the computer (e.g., when compiled and executed) to perform functions described herein.

The STA processor 1210 may include an intelligent hardware device, e.g., a CPU, a microcontroller, an ASIC, and the like. The STA processor 1210 may process information received through the STA transceiver 1240 or to be sent to the STA transceiver 1240 for transmission through the antennas 1250. The STA processor 1210 may handle, alone or in connection with the STA bandwidth selector 1015-b, various related to channel bonding to support 80+80, 160, and 165 MHz bandwidth modes.

The STA transceiver 1240 may be configured to communicate bi-directionally with APs 105 in FIGS. 1, 3-5, and 9. The STA transceiver 1240 may be implemented as at least one transmitter and at least one separate receiver. The STA transceiver 1240 may include a modem configured to modulate the packets and provide the modulated packets to the antennas 1250 for transmission, and to demodulate packets received from the antennas 1250. While the wireless device 110-d may include multiple antennas, there may be aspects in which the wireless device 110-d may include a single antenna 1250.

According to the architecture of FIG. 12, the wireless device 110-d may further include a STA communications manager 1230. The STA communications manager 1230 may manage communications with various access points. The STA communications manager 1230 may be a component of the wireless device 110-d in communication with some or all of the other components of the wireless device 110-d over the at least one interface 1205. Alternatively, functionality of the STA communications manager 1230 may be implemented as a component of the STA transceiver 1240, as a computer program product, or as at least one controller element of the STA processor 1210.

The wireless device 110-d may further include a STA segment parser 1235. The STA segment parser 1235 may parse bandwidth segments in order to perform channel bonding, such as in the 80+80 bandwidth mode. In some examples, the STA segment parser 1235 is part of the STA transceiver 1240.

The components of the wireless device 110-d may be configured to implement aspects discussed above with respect to FIGS. 1-6, 10, and 11, and those aspects may not be repeated here for the sake of brevity. Moreover, the components of the wireless device 110-d may be configured to implement aspects discussed below with respect to FIGS. 13 and 14, and those aspects may not be repeated here also for the sake of brevity.

FIG. 12B shows a diagram 1200-b that illustrates a wireless device 110-e configured for operating in multiple bandwidth modes, including a 20, 40, 80, 80+80, 160, and 165 MHz bandwidth modes. The wireless device 110-e may be an example of the wireless devices 110 of FIGS. 1, 3-5, and 12A.

The wireless device 110-e may include a STA processor 1210-a, a STA memory 1220-a, a STA transceiver 1240-a, antennas 1250-a, and a STA bandwidth selector 1015-c. The STA bandwidth selector 1015-c may be an example of the STA bandwidth selector 1015 of FIGS. 10, 11, and 12A. Each of these components may be in communication with each other, directly or indirectly, over at least one interface 1205-a. The components of the wireless device 110-e may perform the functions of the corresponding components in FIG. 12A.

The STA memory 1220-a may store computer-readable, computer-executable software code containing instructions that are configured to, when executed, cause the STA processor 1210-a to perform various functions described herein for channel bonding. The STA memory 1220-a may include the STA bandwidth selector 1015-c, a STA communications manager 1230-a, and a STA segment parser 1235-a, which may perform the functions of the corresponding components in FIG. 12A. Alternatively, the STA bandwidth selector 1015-c, the STA communications manager 1230-a, and the STA segment parser 1235-a may not be directly executable by the STA processor 1210 but be configured to cause the computer (e.g., when compiled and executed) to perform functions described herein. The STA processor 1210-a may handle, alone or in connection with the STA bandwidth selector 1015-c, various related to channel bonding to support 80+80, 160, and 165 MHz bandwidth modes.

The components of the wireless device 110-e may be configured to implement aspects discussed above with respect to FIGS. 1-6, 10-11, and 12A, and those aspects may not be repeated here for the sake of brevity. Moreover, the components of the wireless device 110-e may be configured to implement aspects discussed below with respect to FIGS. 13 and 14, and those aspects may not be repeated here also for the sake of brevity.

### Example Operating Mode Notification to Support Reduced N_{SS} Definitions

Certain IEEE specifications do not support having different maximum Nss, for example, a first Nss for packet bandwidths of 160/80+80 MHz and a second Nss for packet bandwidths of 80 MHz or lower. Such support would provide an advantage architecturally, allowing wireless devices to use two 80 MHz chains (e.g., transmit chains, receive chains) to transmit or receive one 160/80+80 MHz stream.

Aspects of the present disclosure provide support for having different N_{SS} for different channel bandwidths, in some cases, through signaling in an Operating Mode field of an Operating Mode Notification. As will be described in greater detail below, various options may be provided to signal such support. For example, in one option, one or more of the (previously) reserved bits in the Operating Mode field may be used to indicate that for 80+80/160 MHz packets, the maximum number of spatial streams (N_{SS}) is reduced from that indicated by the N_{SS} field of the Operating Mode field. According to another option, the one or more (previously) reserved bits of the Operating Mode field may be mapped into a table of possible interpretations of the value of the N_{SS} field (as shown in FIG. 16). The table may comprise entries defining how the value of the N_{SS} field of the Operating Mode field is to be interpreted.

FIG. 13 illustrates example operations 1300 for wireless communication, in accordance with various aspects of the present disclosure. For clarity, the operations 1300 are described below with reference to aspects of one or more of the APs 105 or wireless devices 110 described with reference to FIGS. 1, 3-5, 9, and 12, or aspects of one or more of the wireless devices 705, 1005 described with reference to FIGS. 7, 8, 10, and 11. In some examples, an AP 105 or wireless device 110 may execute one or more sets of codes to control the functional elements of the AP 105 or wireless device 110 to perform the functions described below. Additionally or alternatively, the AP 105 or wireless device 110 may perform one or more of the functions described below using hardware made to perform that specific purpose. For illustrative purposes, FIG. 13 is discussed in terms of an AP 105. However, a wireless device 110 may also perform the functions described below.

At block 1302, the method 1300 may include generating a frame comprising: at least one bit indicating an operating bandwidth mode associated with a set of bandwidths, a first field having a value indicating a first number of spatial streams supported by the apparatus associated with a first subset of the set of bandwidths, and one or more bits indicating how the value of the first field is to be processed for determining a second number of spatial streams supported by the apparatus on a given bandwidth in the set of bandwidths for transmission of one or more packets to the apparatus. For example and with reference to FIGS. 9A and 16, an apparatus, such as AP Processor 910 of AP 105-d shown in FIG. 9, may generate a frame containing an Operating Mode field and set bits of a Supported Channel Width Set subfield of the Operating Mode field to indicate an operating bandwidth mode associated with a set of bandwidths. An exemplary bandwidth mode for the first example may include a 20 MHz bandwidth, a 40 MHz bandwidth, an 80 MHz bandwidth, a 160 MHz bandwidth, and an 80+80 MHz bandwidth.

At 1304, the operations 1300 may include outputting the frame for transmission. Continuing the first example above and with reference to FIGS. 9A and 15-16, the AP Processor 910 may output, via the interface 905, the frame for transmission via the AP transceiver 930 and one or more antennas 940.

As used herein, processing of the value of the first field of the frame may include using the value as a number of spatial streams, multiplying the value by a factor to determine the number of spatial streams, or referring to a set of values and corresponding numbers of spatial streams to determine the number of spatial streams.

FIG. 14 illustrates example operations 1400 for wireless communication, in accordance with various aspects of the present disclosure. The operations 1400 may be considered complementary to the operations 1300 described above, for example, performed by a device receiving the frame transmitted in FIG. 13. In some examples, an AP 105 or wireless device 110 may execute one or more sets of codes to control the functional elements of the AP 105 or wireless device 110 to perform the functions described below. Additionally or alternatively, the AP 105 or wireless device 110 may perform one or more of the functions described below using hardware made to perform that specific purpose. For illustrative purposes, FIG. 14 is discussed in terms of a wireless device 110. However, an AP 105 may also perform the functions described below.

At block 1402, the operations 1400 may include obtaining (e.g., actually receiving or obtaining by a processor from an RF front end) a first frame. In a first example and with reference to FIGS. 12A and 16, an apparatus, such as STA Processor 1210 of STA 110-d shown in FIG. 12, may obtain a frame containing an Operating Mode field, a Supported Channel Width Set subfield, and a Max/Half N_{SS} subfield of the Operating Mode field.

At 1404, the operations 1400 may include determining, based at least one bit in the first frame, an operating bandwidth mode associated with a set of bandwidths. Continuing the first example above and with reference to FIGS. 12A and 16, the STA Processor 1210 may determine, based on the Supported Channel Width Set subfield, an operating bandwidth mode associated with a 20 MHz bandwidth, a 40 MHz bandwidth, an 80 MHz bandwidth, a 160 MHz bandwidth, and an 80+80 MHz bandwidth.

At 1406, the operations 1400 may include determining, based on a value of a first field in the first frame, a first number of spatial streams supported by a wireless device associated with a first subset of the set of bandwidths. Continuing the first example above and with reference to FIGS. 1, 12A, and 16, the STA Processor 1210 may determine, based on a value in an R_{X} Nss field of the Operating Mode field of the frame, the AP 105 supports eight spatial streams in the set of the 20 MHz bandwidth, the 40 MHz bandwidth, and the 80 MHz bandwidth.

At 1408, the operations 1400 may include determining, based on one or more bits in the first frame, how to process the value of the first field. Continuing the first example above and with reference to FIGS. 1, 12A, and 16, the STA Processor 1210 may determine, based on two bits of the Max/Half NSS subfield of the Operating Mode field of the frame, that the AP 105 supports half as many spatial streams in the set of the 160 MHz bandwidth and the 80+80 MHz bandwidth.

At 1410, the operations 1400 may include determining a second number of spatial streams supported by the wireless device on a given bandwidth in the set of bandwidths for reception of a packet, based on the determined processing of the value of the first field. Continuing the first example above and with reference to FIGS. 1, 12A, and 16, the STA Processor 1210 may determine the AP 105 supports four spatial streams in the 160 MHz bandwidth, based on the value in the R_{X} Nss field of the Operating Mode field of the frame, and the determined processing being to multiply the R_{X} Nss field by one-half.

At 1412, the operations 1400 may include generating a second frame for transmission to the wireless device on the given bandwidth using the second number of spatial streams. Continuing the first example above and with reference to FIGS. 1, 12A, and 16, the STA Processor 1210 may generate a second frame for transmission to the AP on the 160 MHz bandwidth using four spatial streams.

At 1414, the operations 1400 may include outputting the second frame for transmission. Continuing the first example above and with reference to FIGS. 1, 12A, and 16, the STA Processor 1210 may output, via the interface 1205, second frame for transmission via the STA transceiver 1240 and the antennas 1250.

Advertising support by a wireless device for the first bandwidth mode and the second bandwidth mode may include signaling a response frame including an OMN element. The OMN element may indicate a parameter selected from the group consisting of an operating bandwidth of the single channel and the number of MIMO spatial streams supported by the wireless device. In some examples, the OMN element may indicate support for a number of MIMO spatial streams lower than the number of spatial streams that the wireless device is capable of supporting. For example, if a first wireless device has VHT capabilities and supports four spatial streams in the 160 MHz bandwidth mode, but a second wireless device to which the first wireless device associates only supports two spatial streams in the 160 MHz bandwidth mode, the first wireless device may send an OMN to reduce the support of the first wireless device to only two spatial streams in the 160 MHz bandwidth mode for communication with the second wireless device.

Aspects of the present disclosure provide possible changes to a format of an OMN in order to support reduced N_{SS} definitions. As noted above, in some cases, it may be desirable to support a reduced number (e.g., half) of spatial streams (N_{SS}) for 80+80 and/or 160 MHz packet bandwidth modes, as compared to an actual value of N_{SS} that is supported by a device for 80 MHz and lower packet bandwidth modes. Aspects of the present disclosure may allow reduced Nss definitions, such that a value of N_{SS} in an Operating Mode field is interpreted as a reduced value (e.g., half) in some cases.

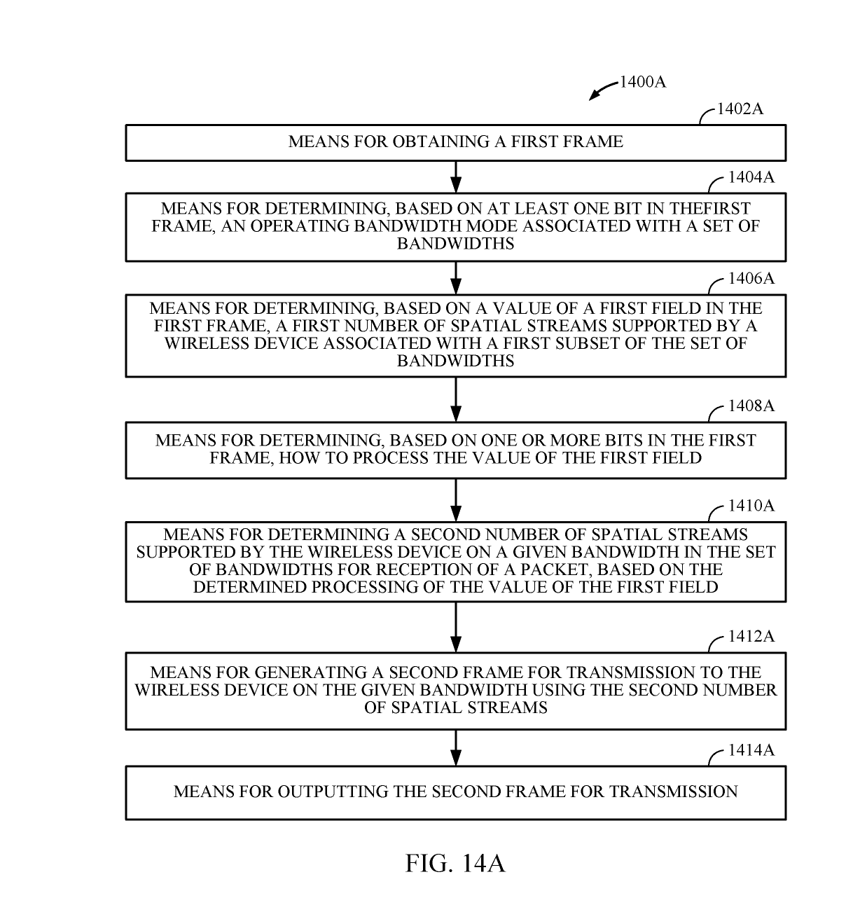

FIG. 15 illustrates an example of such an Operating Mode field 1500, in which a field with previously reserved bits (now labeled Max/Half N_{SS}) is used to indicate how values of the R_{X} Nss field are interpreted. The exemplary Operating Mode field includes eight bits, B0 through B7, with bits B0 and B1 referred to as a Channel Width field (sometimes referred to as a Supported Channel Width Set field) 1502, bits B2 and B3 being previously reserved bits and referred to as a Max/Half N_{SS} field 1504, bits B4-B6 being referred to as an Rx N_{SS} field 1506, and bit B7 being referred to as an Rx N_{SS} Type field 1508. As an example, if the Channel Width field of the Operating Mode field is indicating 80+80/160 MHz (because the Channel Width field is set to 3, with reference to the IEEE 802.11ac standard), in some cases, the reserved bits may be used to indicate that the value of R_{X} Nss should be interpreted using the reduced N_{SS} definition.

As noted above, one option is to use one of the reserved bits (e.g., when it is set to the opposite of the defined reserved value) to indicate that the value of R_{X} Nss given in B4 to B6 should be interpreted as being the (actual) max/full R_{X} Nss for packet bandwidth modes up to 80 MHz, while for 80+80/160 MHz packet bandwidth modes the supported number of spatial streams is only half of this. On the other hand, if the reserved bit is not set to the opposite of the reserved value, the Rx N_{SS} should be interpreted as being the maximum supported number of spatial streams for all packet bandwidth modes fitting in the channel width.

As noted above, another option is to use the two reserved bits and map them to different interpretations of values of the R_{X} Nss field. In this case, the channel width indicated by the OMN together with these two reserved bits may convey the same information as shown in the table in FIG. 16. In other words, the meaning of R_{X} Nss for a given Channel Width may be determined based on the third column, depending on the value of the two previously reserved bits (Max/Half N_{SS} bits).

Another option is to use one of the reserved bits (e.g., when set to the reserved value) to indicate that the value of R_{X} NSS given in B4 to B6 should be interpreted as being the actual number of supported spatial streams for packet bandwidth modes up to the 80 MHz mode, while for the 80+80 and 160 MHz packet bandwidth modes the supported number of spatial streams is zero. In this option, if the reserved bit is not set to the reserved value, then the value in the Rx N_{SS} field should be interpreted by modifying the value with a multiplier, which may be specific to each packet bandwidth mode, to determine the number of supported spatial streams for that packet bandwidth mode. That is, each packet bandwidth mode may have an associated multiplier for determining the actual supported number of spatial streams for that packet bandwidth mode. The multiplier may, for example, be determined from a set of multipliers (e.g., in a table) based on the reserved bit, packet bandwidth mode, and advertised capabilities of the wireless device transmitting the packet containing the Operating Mode field.

FIG. 16 illustrates an example mapping 1600 of bits of the Operating Mode field 1500 of FIG. 15, in accordance with aspects of the present disclosure. In the exemplary mapping, the Channel Width field 1502 of FIG. 15 is found in a Supported Channel Width Set column 1602, while the Max/Half N_{SS} field 1504 is found in a Max/Half N_{SS} (Reserved) Bits column 1604. The meaning of each of the combinations of the Supported Channel Width Set fields and the Max/Half N_{SS} (Reserved) Bits fields is found in the Meaning column 1606. For example, if an Operating Mode field is set to 0b00000110, then the Channel Width field and the Max/Half N_{SS} field are both 0, and the meaning would be read from the row labeled 1610. Still in the example, the meaning would be that the transmitting STA supports 4 spatial streams (because the three bits of the Rx N_{SS} field are set to 0b011, indicating N_{SS}=4) in 20, 40, and 80 MHz packet bandwidth modes, and the transmitting STA does not support the 160 MHz and 80+80 packet bandwidth modes. In a second example, if an Operating Mode field is set to 0b01110110), then the Channel Width field is 1 and the Max/Half N_{SS} field is 3, and the meaning would be read from the row labeled 1612. Still in the second example, the meaning would be that the transmitting STA supports 8 spatial streams (2*4 spatial streams, because the meaning is to multiply N_{SS} by 2 and the three bits of the Rx N_{SS} field are set to 0b011, indicating N_{SS}=4) in 20, 40, 80, and 160 MHz packet bandwidth modes, and the transmitting STA supports N_{SS}=4 spatial streams in the 80+80 MHz packet bandwidth mode.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 1300 and 1400 illustrated in FIGS. 13 and 14 correspond to means 1300A and 1400A illustrated in FIGS. 13A and 14A, respectively.

For example, means for transmitting or means for providing may comprise a transmitter (e.g., the AP transmitter 720), a transceiver (e.g., the AP transceiver 930) and/or an antenna(s) 940 of the access point 105 illustrated in FIGS. 7-9B or the STA transmitter 1020, the STA transceiver 1240 and/or an antenna(s) 1250 depicted in FIGS. 10-12B. Means for receiving or means for obtaining may comprise a receiver (e.g., the AP receiver 710), a transceiver (e.g., the AP transceiver 930) and/or an antenna(s) 940 of the access point 105 illustrated in FIGS. 7-9B or the STA receiver 1010, the STA transceiver 1240 and/or antenna(s) 1250 depicted in FIGS. 10-12B. Means for generating, means for determining, means for providing, means for outputting, means for obtaining a frame, means for obtaining an indication, means for processing portions of a frame, means for obtaining, means for selecting, and means for setting (e.g. a value of a bit or field in a frame) may comprise a processing system, which may include one or more processors, such as the AP bandwidth selector 715, the AP processor 910, the AP communications manager 950, the AP transceiver 930, and/or the AP communications component 960 of the access point 105 illustrated in FIGS. 7-9B or the STA bandwidth selector 1015, the STA processor 1210, the STA communications manager 1230, and/or the STA transceiver 1240 portrayed in FIGS. 10-12B. Means for outputting may comprise one or more interfaces (e.g., interface 905, interface 1205) between one or more processors and transmitters and/or transceivers.

According to certain aspects, such means may be implemented by processing systems configured to perform the corresponding functions by implementing various algorithms (e.g., in hardware or by executing software instructions) described above for having different N_{SS} for different channel bandwidths. For example, means for generating a frame having at least one bit indicating support by the apparatus for a set of packet bandwidth modes may be implemented by a processing system performing an algorithm that identifies supported packet bandwidth modes based on a configuration of the apparatus, means for providing a first field in the frame having a value indicating a number of spatial streams supported by the apparatus in a first subset of these packet bandwidth modes may be implemented by a (same or different) processing system performing an algorithm that takes, as input, the first subset of packet bandwidth modes and a configuration of the apparatus, while means for providing one or more bits in the frame indicating how the value of the first field is to be interpreted, by a device receiving the frame, when the device subsequently receives a packet with a bandwidth in a second subset of the set of packet bandwidth modes may be implemented by a (same or different) processing system performing an algorithm that takes, as input, the second subset of packet bandwidth modes and a configuration of the apparatus. In other examples, means for determining, based on one or more bits in a frame, how to interpret a value of a first field in the frame may be implemented by a (same or different) processing system performing an algorithm that takes, as input, the value of the first field of the frame and/or bits in other fields of the frame, and means for determining a number of spatial streams supported by a wireless device based on the determined interpretation of the value of the first field may be implemented by a (same or different) processing system performing an algorithm that takes, as input, the value of the first field, the determined interpretation, and one or more other fields of the frame.

The detailed description set forth above in connection with the appended drawings describes examples and does not represent the only examples that may be implemented or that are within the scope of the claims. The term “example” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

1. An apparatus for wireless communications, comprising:
a processing system configured to generate a frame comprising:
at least one bit indicating an operating bandwidth mode associated with a set of bandwidths,
a first field having a value indicating a first number of spatial streams supported by the apparatus associated with a first subset of the set of bandwidths, and
one or more bits indicating how the value of the first field is to be processed for determining a second number of spatial streams supported by the apparatus on a given bandwidth in the set of bandwidths for transmission of one or more packets to the apparatus; and
an interface configured to output the frame for transmission.

2. The apparatus of claim 1, wherein the second number of spatial streams comprises a number of spatial streams to be used for transmission to the apparatus of one or more packets on a bandwidth in a second subset of the set of bandwidths.

3. The apparatus of claim 1, wherein the processing system is further configured to:
set the one or more bits to a first value to indicate the value of the first field is to be interpreted as the second number of spatial streams supported by the apparatus; and
set the one or more bits to a second value to indicate the value of the first field is to be interpreted as the second number of spatial streams less than the value of the first field.

4. The apparatus of claim 1, wherein the processing system is further configured to:
set the one or more bits based on entries in a table defining how the value of the first field is to be processed.

5. The apparatus of claim 1, wherein the processing system is further configured to:
set the at least one bit to a value that indicates the set includes a first bandwidth, and
set the one or more bits to a value indicating the apparatus supports the second number of spatial streams that is less than a third number of spatial streams that the apparatus is capable of supporting in the first bandwidth.

6. The apparatus of claim 1, wherein:
the at least one bit comprises at least one of the one or more bits.

7. An apparatus for wireless communications, comprising:
a first interface configured to obtain a first frame;
a processing system configured to:
determine, based on at least one bit in the first frame, an operating bandwidth mode associated with a set of bandwidths,
determine, based on a value of a first field in the first frame, a first number of spatial streams supported by a wireless device associated with a first subset of the set of bandwidths,
determine, based on one or more bits in the first frame, how to process the value of the first field,
determine a second number of spatial streams supported by the wireless device on a given bandwidth in the set of bandwidths for reception of a packet, based on the determined processing of the value of the first field, and
generate a second frame for transmission to the wireless device on the given bandwidth using the second number of spatial streams; and
a second interface configured to output the second frame for transmission.

8. The apparatus of claim 7, wherein the processing system is configured to determine the wireless device supports the second number of spatial streams for reception of one or more packets on a bandwidth in a second subset of the set of bandwidths.

9. The apparatus of claim 7, wherein the processing system is further configured to:
interpret the value of the first field as the second number of spatial streams if the one or more bits are set to a first value; and
interpret the value of the first field as the second number of spatial streams less than the value of the first field if the one or more bits are set to a second value.

10. The apparatus of claim 7, wherein the processing system is configured to:
determine how to process the value of the first field based on entries in a table corresponding to the one or more bits.

11. The apparatus of claim 7, wherein:
the processing system is further configured to:
determine that the second number of spatial streams is less than a third number of spatial streams that the apparatus is capable of supporting on the given bandwidth.

12. The apparatus of claim 7, wherein:
the at least one bit comprises at least one of the one or more bits.

13. A method for wireless communications by an apparatus, comprising:
generating a frame comprising:
at least one bit indicating an operating bandwidth mode associated with a set of bandwidths,
a first field having a value indicating a first number of spatial streams supported by the apparatus associated with a first subset of the set of bandwidths, and
one or more bits indicating how the value of the first field is to be processed for determining a second number of spatial streams supported by the apparatus on a given bandwidth in the set of bandwidths for transmission of one or more packets to the apparatus; and
outputting the frame for transmission.

14. The method of claim 13, wherein the second number of spatial streams comprises a number of spatial streams to be used for transmission to the apparatus of one or more packets on a bandwidth in a second subset of the set of bandwidths.

15. The method of claim 13, further comprising:
setting the one or more bits to a first value to indicate the value of the first field is to be interpreted as the second number of spatial streams supported by the apparatus or to a second value to indicate the value of the first field is to be interpreted as the second number of spatial streams less than the value of the first field.

16. The method of claim 13, further comprising:
setting the one or more bits based on entries in a table defining how the value of the first field is to be processed.

17. The method of claim 13, further comprising:
setting the at least one bit to a value that indicates the set includes a first bandwidth; and
setting the one or more bits to a value indicating the apparatus supports the second number of spatial streams that is less than a third number of spatial streams that the apparatus is capable of supporting in the first bandwidth.

18. The method of claim 13, wherein:
the at least one bit comprises at least one of the one or more bits.

19. A method for wireless communications by an apparatus, comprising:
obtaining a first frame;
determining, based on at least one bit in the first frame, an operating bandwidth mode associated with a set of bandwidths;
determining, based on a value of a first field in the first frame, a first number of spatial streams supported by a wireless device associated with a first subset of the set of bandwidths;
determining, based on one or more bits in the first frame, how to process the value of the first field;
determining a second number of spatial streams supported by the wireless device on a given bandwidth in the set of bandwidths for reception of a packet, based on the determined processing of the value of the first field;
generating a second frame for transmission to the wireless device on the given bandwidth using the second number of spatial streams; and
outputting the second frame for transmission.

20. The method of claim 19, wherein determining the second number of spatial streams comprises determining the wireless device supports the second number of spatial streams for reception of one or more packets on a bandwidth in a second subset of the set of bandwidths.

21. The method of claim 19, wherein determining how to process the value of the first field comprises:
determining to interpret the value of the first field as the second number of spatial streams if the one or more bits are set to a first value; and
determining to interpret the value of the first field as the second number of spatial streams less than the value of the first field if the one or more bits are set to a second value.

22. The method of claim 19, wherein determining how to process the value of the first field comprises:
determining how to process the value of the first field based on entries in a table corresponding to the one or more bits.

23. The method of claim 19, further comprising:
determining that the second number of spatial streams is less than a third number of spatial streams that the apparatus is capable of supporting on the given bandwidth.

24. The method of claim 19, wherein:
the at least one bit comprises at least one of the one or more bits.

25-40. (canceled)
